(19) United States
(12) Patent Application Publication
(10) Pub. No.: US 2026/0171490 A1
(43) Pub. Date: Jun. 18, 2026

(54) IONOGEL ELECTROLYTES, FORMING METHODS AND APPLICATIONS OF SAME

(71) Applicant: NORTHWESTERN UNIVERSITY, Evanston, IL (US)

(72) Inventors: Mark C. Hersam, Wilmette, IL (US); Cory M. Thomas West, Evanston, IL (US); Woo Jin Hyun, Shantou, Guangdong (CN)

(21) Appl. No.: 18/845,065

(22) PCT Filed: Mar. 15, 2023
(86) PCT No.: PCT/US2023/064361

§ 371 Date: Sep. 9, 2024

Related U.S. Application Data
(63) Continuation-in-part of application No. 17/968,180, filed on Oct. 18, 2022.
Application No. 17/968,180 is a continuation-in-part of application No. 17/798,618, now Pat. No. 12,473,451.
Application No. PCT/US2023/064361 is a continuation-in-part of application No. 17/798,618, filed on Aug. 10, 2022, now Pat. No. 12,473,451.
Application No. 17/798,618 is a continuation-in-part of application No. PCT/US2021/052307, filed on Sep. 28, 2021.
(60) Provisional application No. 62/975,282, filed on Feb. 12, 2020.
(60) Provisional application No. 63/085,240, filed on Sep. 30, 2020.
(60) Provisional application No. 63/324,311, filed on Mar. 28, 2022.
(60) Provisional application No. 63/327,854, filed on Apr. 6, 2022.

(51) Int. Cl. H01M 10/0565; H01M 10/052

(52) U.S. Cl. CPC H01M 10/0565; H01M 10/052; H01M 2300/0085; H01M 2300/0091

(57) ABSTRACT

An ionogel includes an ionic liquid electrolyte (ILE) comprising an ionic liquid (e.g., 1-ethyl-3-methyl-imidazolium bis(fluorosulfonyl)imide (EMIM-FSI)) and a lithium salt (e.g., lithium bis(fluorosulfonyl)imide (LiFSI)) dissolved in the ionic liquid; and a solid matrix material comprising hexagonal boron nitride (hBN) nanoplatelets mixed with the ionic liquid electrolyte in at least one solvent.

### CROSS-REFERENCE TO RELATED PATENT APPLICATIONS

This application claims priority to and the benefit of U.S. Provisional Application Nos. 63/324,311, filed Mar. 28, 2022, and 63/327,854, filed Apr. 6, 2022.

This application is a continuation in part application of U.S. patent application Ser. No. 17/968,180, filed Oct. 18, 2022, which is a continuation in part application of U.S. patent application Ser. No. 17/798,618, filed Aug. 10, 2022, which is a U.S. national stage entry of PCT Patent Application No. PCT/US2021/015375, filed Jan. 28, 2021, which itself claims priority to and the benefit of U.S. Provisional Patent Application No. 62/975,282, filed Feb. 12, 2020.

This application is a continuation in part application of U.S. patent application Ser. No. 17/798,618, filed Aug. 10, 2022, which is a U.S. national stage entry of PCT Patent Application No. PCT/US2021/015375, filed Jan. 28, 2021, which itself claims priority to and the benefit of U.S. Provisional Patent Application No. 62/975,282, filed Feb. 12, 2020.

This application is also a continuation in part application of PCT Patent Application No. PCT/US2021/052307, filed Sep. 28, 2021, which itself claims priority to and the benefit of U.S. Provisional Patent Application No. 63/085,240, filed Sep. 30, 2020.

Each of the above-identified applications is incorporated herein in its entirety by reference.

### STATEMENT AS TO RIGHTS UNDER FEDERALLY-SPONSORED RESEARCH

This invention was made with government support under grant numbers 2037026, 1842165 and 1720139 awarded by the National Science Foundation. The government has certain rights in the invention.

### FIELD OF THE INVENTION

The present invention relates generally to batteries, and more particularly to ionogel electrolytes, forming methods and applications of the same.

### BACKGROUND OF THE INVENTION

The background description provided herein is for the purpose of generally presenting the context of the invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the invention.

Next-generation energy storage technologies are necessary to fulfill the ever-increasing demands for electric vehicles, grid-level energy storage, and portable electronic devices. Although traditional lithium-ion batteries are widely available, they suffer from limitations in energy density and poor safety due to the use of a volatile liquid electrolyte. In recent years, lithium metal anodes have gained interest since they offer an exceptionally high theoretical specific capacity (3860 mAh g⁻¹) that is an order of magnitude higher than incumbent graphitic anode materials (372 mAh g⁻¹). However, traditional organic liquid electrolytes, when combined with a lithium-metal anode, are susceptible to poor cycling stability and dendritic lithium growth, which can result in internal short circuits and catastrophic failure. As a result, significant attention has been devoted to solid-state electrolytes (SSEs) that enable the use of lithium metal anodes while concurrently minimizing flammability concerns by using non-volatile components. Despite this promise, state-of-the-art SSEs suffer from a combination of pitfalls including poor room-temperature ionic conductivity, unstable interfaces with lithium-ion battery electrode materials, and expensive, non-scalable processing methods that have limited commercial viability.

Therefore, a heretofore unaddressed need exists in the art to address the aforementioned deficiencies and inadequacies.

### SUMMARY OF THE INVENTION

In one aspect, this invention relates to an ionogel comprising an ionic liquid electrolyte (ILE) comprising an ionic liquid (e.g., 1-ethyl-3-methyl-imidazolium bis(fluorosulfonyl)imide (EMIM-FSI)) and a lithium salt (e.g., lithium bis(fluorosulfonyl)imide (LiFSI)) dissolved in the ionic liquid; and a solid matrix material comprising hexagonal boron nitride (hBN) nanoplatelets mixed with the ionic liquid electrolyte in at least one solvent.

In one embodiment, the EMIM-FSI has relatively low viscosity and high ionic conductivity of the imidazolium cation, while the FSI anion provides cathodic stability down to 0 V vs. Li/Li⁺.

In one embodiment, the ILE has a high concentration of the LiFSI for enhancing the stability of lithium plating and generating a favorable LiF-rich solid electrolyte interface (SEI) with lithium metal.

In one embodiment, the ILE contains about 30-50 mol % of the LiFSI.

In one embodiment, the hBN nanoplatelets comprise exfoliated hBN nanoplatelets.

In one embodiment, each exfoliated hBN nanoplatelet is coated with a thin amorphous carbon coating.

In one embodiment, the hBN Nanoplatelets have desirable physical properties including thermal stability, chemical inertness, electrically insulating nature, and mechanical robustness.

In one embodiment, the hBN nanoplatelets have the high surface area for generating strong interactions with the ILE, thereby confining the ILE and generating a high mechanical modulus gel that is greater than about 1 MPa.

In one embodiment, the at least one solvent is a polar solvent selected to create a well-mixed slurry and provide favorable thermodynamic properties for thermal removal.

In one embodiment, the ionogel has a viscosity that is tunable by the at least one solvent.

In one embodiment, the at least one solvent is adapted to tune the viscosity of the ionogel to match that of existing commercial blade coating slurries (i.e., ˜10⁴ cP at a shear rate of 100 s⁻¹) used in high-throughput coating equipment.

In one embodiment, the at least one solvent is operably removable with a thermal treatment.

In one embodiment, the at least one solvent comprises N,N-dimethylformamide (DMF), diglyme, N-methyl-pyrrolidone, or 1,4-dioxane.

In one embodiment, the ionogel has about 15-25 wt % of the hBN nanoplatelets, about 25-35 wt % of the ILE, and greater than 50 wt % of the at least one solvent.

In one embodiment, the ionogel is a blade-coatable ionogel that is capable of forming a blade-coated film having a thickness of less than about 40 μm with crack-free without use of a polymeric binder.

In one embodiment, the ionogel is coatable directly onto a composite cathode, and providing excellent interfacial contact with low impedance.

In one embodiment, the blade-coated film is a blade-coated solid-state electrolyte (SSE) film for a lithium metal battery (LMB).

In one embodiment, the SSE film has sufficient mechanical stiffness to inhibit growth of lithium dendrites with a storage modulus of greater than about 1 MPa, while also provides excellent interfacial contact to the composite cathode and a lithium metal anode.

In one embodiment, the SSE film is electrochemically stable against lithium metal enabling its utilization in LFP|Li cells that can be cycled at 1C rate with an about 78% capacity retention after about 500 cycles at room temperature.

In one embodiment, the thermal stability of the hBN nanoplatelets and the ILE allows for operation of LFP|Li cells at about 60° C. with an about 33% improvement in gravimetric capacity at 1C compared to room temperature.

In one embodiment, ionic conductivity of the ionogel remains high with values of about 1.6 mS cm-1 and about 5.5 mS cm-1 at room temperature and about 60° C., respectively.

In another aspect, the invention relates to an ionogel comprising an ionic liquid electrolyte (ILE); and a solid matrix material mixed with the ionic liquid electrolyte. In one embodiment, the ILE comprises an ionic liquid comprising at least one of 1-ethyl-3-methyl-imidazolium bis(fluorosulfonyl)imide (EMIM-FSI), 1-ethyl-3-methyl-imidazolium bis(trifluoromethylsulfonyl)imide (EMIM-TFSI), N-methyl-N-propylpyrrolidinium bis(trifluoromethylsulfonyl)imide (Py₁₃-TFSI), and N-methyl-N-propylpyrrolidinium bis(fluorosulfonyl)imide (Py₁₃-TFSI), or a combination of the ionic liquid along with an lithium salt comprising at least one of lithium bis(fluorosulfonyl)imide (LiFSI), lithium bis(trifluoromethylsulfonyl)imide (LiTFSI), and lithium bis(oxalato) borate (LiBOB), or a combination of the lithium salt dissolved in the ionic liquid.

In one embodiment, the solid matrix material is selected to have desirable physical properties including thermal stability, chemical inertness, electrically insulating nature, and mechanical robustness.

In one embodiment, the solid matrix material comprises boron nitride nanosheets (BNNS), borocarbonitrides (BCN), oxide nanosheets, layered perovskites, hydroxide nanosheets including hydrotalcite-like layered double hydroxides, natural clays including bentonites and montmorillonites, or a combination of them.

In one embodiment, the oxide nanosheets comprise Al₂O₃, TiO₂ (anatase and rutile), ZrO₂, Nb₂O₅, HfO₂, CaCu₃Ti₄O₁₂, Pb(Zr,Ti)O₃, (Pb,La)(Zr,Ti)O₃, SiO₂, Al₂O₃, HfSiO₄, ZrO₂, HfO₂, Ta₂O₅, La₂O₃, LaALO₃, Nb₂O₅, BaTiO₃, SrTiO₃, Ta₂O₅, or a combination of them.

In one embodiment, the BNNS comprises hexagonal boron nitride (hBN) nanoplatelets.

In one embodiment, the hBN nanoplatelets comprise exfoliated hBN nanoplatelets.

In one embodiment, each exfoliated hBN nanoplatelet is coated with a thin amorphous carbon coating.

In one embodiment, the solid matrix material is mixed with the ionic liquid electrolyte in at least one solvent.

In one embodiment, the at least one solvent is a polar solvent selected to create a well-mixed slurry as well as provide favorable thermodynamic properties for thermal removal.

In one embodiment, the ionogel has a viscosity that is tunable by the at least one solvent.

In one embodiment, the at least one solvent is adapted to tune the viscosity of the ionogel to match that of existing commercial blade coating slurries used in high-throughput coating equipment. The viscosity of existing commercial blade coating slurries is about 10⁴ cP at a shear rate of 100 s⁻¹.

In one embodiment, the at least one solvent is operably removable with a thermal treatment.

In one embodiment, the at least one solvent comprises N,N-dimethylformamide (DMF).

In one embodiment, the ionogel is a blade-coatable ionogel that is capable of forming a blade-coated film having a thickness of less than about 40 μm with crack-free without use of a polymeric binder.

In one embodiment, the ionogel is coatable directly onto a composite cathode, and providing excellent interfacial contact with low impedance.

In one embodiment, the blade-coated film is a blade-coated solid-state electrolyte (SSE) film for a lithium metal battery (LMB).

In one embodiment, the SSE film has sufficient mechanical stiffness to inhibit growth of lithium dendrites with a storage modulus of greater than about 1 MPa, while also provides excellent interfacial contact to the composite cathode and a lithium metal anode.

In one embodiment, the SSE film is electrochemically stable against lithium metal enabling its utilization in LFP|Li cells that can be cycled at 1C rate with an about 78% capacity retention after about 500 cycles at room temperature.

In one embodiment, the thermal stability of the hBN nanoplatelets and the ILE allows for operation of LFP|Li cells at about 60° C. with an about 33% improvement in gravimetric capacity at 1C compared to room temperature.

In one embodiment, ionic conductivity of the ionogel remains high with values of about 1.6 mS cm⁻¹ and about 5.5 mS cm⁻¹ at room temperature and about 60° C., respectively.

In one embodiment, the ionogel has about 15-25 wt % of the solid matrix material, about 25-35 wt % of the ILE, and greater than 50 wt % of the at least one solvent.

In yet another aspect, the invention relates to a device comprising one or more components formed of the ionogel as disclosed above.

In one embodiment, the device is one or more batteries, one or more supercapacitors, or any combination of them.

In a further aspect, the invention relates to a method for forming an ionogel, comprising providing an ionic liquid electrolyte (ILE) and a solid matrix material; and mixing the solid matrix material with the ILE in at least one solvent.

In one embodiment, the ILE comprises an ionic liquid comprising at least one of 1-ethyl-3-methyl-imidazolium bis(fluorosulfonyl)imide (EMIM-FSI), 1-ethyl-3-methyl-imidazolium bis(trifluoromethylsulfonyl)imide (EMIM-TFSI), N-methyl-N-propylpyrrolidinium bis(trifluoromethylsulfonyl)imide (Py₁₃-TFSI), and N-methyl-N-propylpyrrolidinium bis(fluorosulfonyl)imide (Py₁₃-TFSI), or a combination of the ionic liquid along with an lithium salt comprising at least one of lithium bis(fluorosulfonyl)imide (LiFSI), lithium bis(trifluoromethylsulfonyl)imide (LiTFSI), and lithium bis(oxalato) borate (LiBOB), or a combination of the lithium salt dissolved in the ionic liquid.

In one embodiment, the solid matrix material is selected to have desirable physical properties including thermal stability, chemical inertness, electrically insulating nature, and mechanical robustness.

In one embodiment, the solid matrix material comprises boron nitride nanosheets (BNNS), borocarbonitrides (BCN), oxide nanosheets, layered perovskites, hydroxide nanosheets including hydrotalcite-like layered double hydroxides, natural clays including bentonites and montmorillonites, or a combination of them.

In one embodiment, the oxide nanosheets comprise Al₂O₃, TiO₂ (anatase and rutile), ZrO₂, Nb₂O₅, HfO₂, CaCu₃Ti₄O₁₂, Pb(Zr,Ti)O₃, (Pb,La)(Zr,Ti)O₃, SiO₂, Al₂O₃, HfSiO₄, ZrO₂, HfO₂, Ta₂O₅, La₂O₃, LaALO₃, Nb₂O₅, BaTiO₃, SrTiO₃, Ta₂O₅, or a combination of them.

In one embodiment, the BNNS comprises hexagonal boron nitride (hBN) nanoplatelets that are obtained by shear-mixing bulk hBN microparticles in ethanol with ethyl cellulose (EC) acting as a dispersing agent to form a shear-mixed dispersion; separating the exfoliated hBN nanoplatelets and EC from the shear-mixed dispersion by centrifuge-assisted sedimentation and flocculation; and collecting hBN/EC solids; and heating the collected hBN/EC solids at a temperature for a period of time to decompose the EC, thereby volatilizing most of the EC, but also leaving behind a thin amorphous carbon coating on the surface of each of the exfoliated hBN nanoplatelets, which contributes to enhanced interactions between the hBN nanoplatelets and the ionic liquids for stronger solidification of the ionogel ink.

In one embodiment, the temperature is about 300-500° C., and the period of time is for about 2-4 hours.

In one embodiment, the ionogel have a viscosity that is tunable by the at least one solvent.

In one embodiment, the at least one solvent is adapted to tune the viscosity of the ionogel to match that of existing commercial blade coating slurries used in high-throughput coating equipment. The viscosity of existing commercial blade coating slurries is about 10⁴ cP at a shear rate of 100 s⁻¹.

In one embodiment, the at least one solvent is operably removable with a thermal treatment.

In one embodiment, the at least one solvent comprises N,N-dimethylformamide (DMF), diglyme, N-methyl-pyrrolidone, or 1,4-dioxane.

These and other aspects of the present invention will become apparent from the following description of the preferred embodiment taken in conjunction with the following drawings, although variations and modifications therein may be affected without departing from the spirit and scope of the novel concepts of the invention.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 shows schematic illustration of an all-solid-state battery construction using the blade-coated hBN ionogel electrolyte, according to embodiments of the invention. Panel a: hBN nanoplatelets are mixed with ionic liquid electrolyte (EMIM-FSI (3.5 M LiFSI)) and a diluent solvent (DMF). Panel b: A cathode composite is blade-coated, dried, and pressed before the hBN ionogel slurry is blade-coated and dried, leaving a thin SSE film on the cathode. Panel c: The electrolyte-coated cathode is then assembled with a lithium metal anode and sealed inside the cell casing.

FIG. 2 shows blade-coatable hBN ionogel slurry, according to embodiments of the invention. Panel a: Scanning electron microscopy (SEM) of the exfoliated hBN nanoplatelets. Panel b: Photograph of the final blade-coatable hBN ionogel slurry including 16.7 wt % hBN, 33.3 wt % EMIM-FSI (3.5 M LiFSI), and 50 wt % DMF as prepared by centrifugal mixing with zirconia mixing balls. Panel c: Ionogel slurry viscosity as a function of shear rate and varying hBN content. Panel d: TGA of the blade-coatable hBN ionogel slurry showing full removal of the DMF solvent at about 170° C. and the degradation of the ILE at about 225° C., leaving only the hBN nanoplatelets at higher temperatures. Panel e: FTIR spectra of various hBN ionogel slurry samples in addition to a dry mixed hBN ionogel control. The initial slurry content of DMF (50 wt %) is reduced by >99% after drying at 160° C. for 30 min as evidenced by the reduction in the peak height of the DMF carbonyl stretch at 1670 cm⁻¹. Panel f: Temperature dependence of ionic conductivity in the hBN ionogel (33.4 wt % hBN, 66.6 wt % EMIM-FSI (3.5 M LiFSI)). The dashed line is a Vogel-Fulcher-Tammann (VFT) model fit to σ=Aexp[−B(T−T0)], where A, B, and TO are 48.8 mS cm⁻¹, 231 K⁻¹, and 229 K, respectively.

FIG. 3 shows blade-coated hBN ionogel, according to embodiments of the invention. Panel a: Blade-coated hBN ionogel thickness measured by laser profilometry is plotted as a function of the blade height setting. LFP electrodes were blade coated with the hBN ionogel slurry and then dried at 160° C. for 30 min before the height measurement. Panel b: Photograph of an LFP electrode blade-coated onto an aluminum current collector. Panel c: Blade-coated hBN ionogel on the same LFP cathode. Panel d: SEM image of the blade-coated hBN ionogel slurry on an LFP cathode. Panel e: Cross-sectional SEM micrograph of an LFP|Li cell showing the hBN ionogel thickness and close interfacial contact to the LFP and Li electrodes. Panel f: Electrochemical impedance spectroscopy (EIS) of LFP|Li cells comparing the impedance of the hBN ionogel electrolyte applied by blade coating or by manual deposition with a spatula and razor blade.

FIG. 4 shows electrochemical performance of the blade-coated hBN ionogel (33.4 wt % hBN, 66.6 wt % EMIM-FSI (3.5 M LiFSI)) in LFP|Li cells at room temperature (22° C.), according to embodiments of the invention. Panel a: Rate capability at various charge/discharge rates of the cells. Panel b: Corresponding voltage profiles of the cells. Panel c: Comparison of recently published reports based on cycling stability of LFP|Li cells with thin (<100 μm) SSEs operating at 20-30° C. Cycles completed refers to the maximum number of cycles reported during cycle stability testing at a given current density. The number labels indicate the citation number. Panel d: Room temperature cycling performance of LFP|Li cells with the blade-coated hBN ionogel electrolyte at a charge/discharge rate of 1C. Panel e: Selected charge/discharge voltage profiles from the 1C rate LFP|Li cycling test.

FIG. 5 shows high temperature (60° C.) performance of LFP|Li cells with the blade-coated hBN ionogel (33.4 wt % hBN, 66.6 wt % EMIM-FSI (3.5 M LiFSI)), according to embodiments of the invention. Panel a: Rate capability at various charge/discharge rates at 60° C. operation. Panel b: Associated voltage profiles at 60° C. operation. Panel c: Comparison of discharge capacity for room temperature and 60° C. operation at various C-rates. Panel d: High-temperature cycling stability of an LFP|Li cell with the blade-coated hBN ionogel electrolyte at a charge/discharge rate of 1C. Panel e: Selected charge/discharge voltage profiles from the cycling stability testing of LFP|Li cells.

FIG. 6 shows photographs of ionogel slurries formulated with 16.7 wt % hBN+EMIM−FSI (3.5 M LiFSI)+50 wt % of various solvents: (panel a) DMF, (panel b) heptane, (panel c) toluene, (d) 1,4-dioxane, (panel e)N-methyl-2-pyrrolidone, and (panel f) ethyl lactate, according to embodiments of the invention.

FIG. 7 shows ionogel slurry viscosity (25° C., 25 mm parallel plate, 0.5 mm gap) as a function of shear rate with varying concentrations of DMF diluent solvent, according to embodiments of the invention.

FIG. 8 shows viscosity of the hBN blade-coatable ionogel slurry (25 mm parallel plate, 25° C.) compared to a commercial aqueous graphite composite slurry (53.6 wt % graphite, 0.8 wt % carbon black, 0.6 wt % SBR binder, 0.6 wt % CMC binder, 44.4 wt % water), according to embodiments of the invention. The aqueous graphite composite slurry data is extracted from Schmidt et al.

FIG. 9 shows optical images of a blade-coated LFP cathode on a carbon-coated aluminum substrate, according to embodiments of the invention. Panels a-b: The LFP cathode is shown before and after the hBN ionogel electrolyte has been blade-coated and dried on top of it. The red square shows the representative location where optical microscopy was conducted. Panels c-f: Optical microscopy of the ionogel film at 5×, 20×, 50×, and 100× magnification showing the film is free of cracks after thermal drying is complete.

FIG. 10 shows electrochemical impedance spectra (EIS) of SS|ionogel|SS symmetric cells at various temperatures, according to embodiments of the invention. The composition of the ionogel studied was 33 wt % hBN and 67 wt % EMIM-FSI (3.5 M LiFSI). The bulk areal resistance extracted from the EIS results between 5° C. and 100° C. were used to calculate the ionic conductivity of the hBN ionogel electrolyte. The area of the SS blocking electrodes was 1.862 cm².

FIG. 11 shows Rheological properties of the hBN ionogel, according to embodiments of the invention. The hBN ionogel including 33.4 wt % hBN and 66.6 wt % EMIM-FSI (3.5 M LiFSI) shows a shear storage modulus higher than the loss modulus across the frequencies tested, indicating a solid structure formed in the hBN ionogel. The dynamic mechanical spectroscopy was conducted at 25° C. with an 8 mm parallel plate operating at 0.1% strain with a gap of 1 mm.

FIG. 12 shows electrochemical impedance spectroscopy (EIS) of LFP|Li cells with hBN ionogel electrolyte applied by blade coating or manual deposition via spatula and razor blade, according to embodiments of the invention. The table above corresponds to panel f of FIG. 3. The equivalent circuit model is shown with the three model resistance values.

FIG. 13 shows electrochemical stability of the blade-coated hBN ionogel, according to embodiments of the invention. Cyclic voltammetry was conducted on a lithium metal cell with a stainless-steel blocking electrode (SS|Li) containing the hBN ionogel electrolyte. The voltage was swept at 1 mV/s from −0.2 V to 3 V vs. Li/Li⁺ with no abnormal electrochemical events other than lithium plating and deposition.

FIG. 14 shows linear sweep voltammetry (LSV) of a SS|Li cell with hBN ionogel electrolyte (33.4 wt % hBN, 66.6 wt % EMIM-FSI) with high (3.5 M) and low (1 M) concentrations of LiFSI, according to embodiments of the invention. The 3.5 M LiFSI ionogel shows enhanced anodic stability compared to the 1 M LiFSI formulation. The voltage was swept at 1 mV/s from 3 V to 6 V vs. Li/Lit.

FIG. 15 shows cyclic voltammetry of an LFP|Li cell with hBN ionogel electrolyte, according to embodiments of the invention. The voltage was swept at 1 m V/s from 2.5 V to 4 V vs. Li/Lit with stable lithiation and delithiation occurring over 5 cycles.

FIG. 16 shows formation cycles of the LFP|Li cells used for cycling stability testing, according to embodiments of the invention. Panel a: Voltage-time curves for the four formation cycles completed via (panel b) pulsed charging (15 s on, 90 s off) at a 1C rate followed by a constant-current discharge also at 1C. The first two cycles included a charging capacity cutoff at ⅓ and ⅔ full charge capacity, respectively, while the latter two cycles utilized a 4 V charging cutoff.

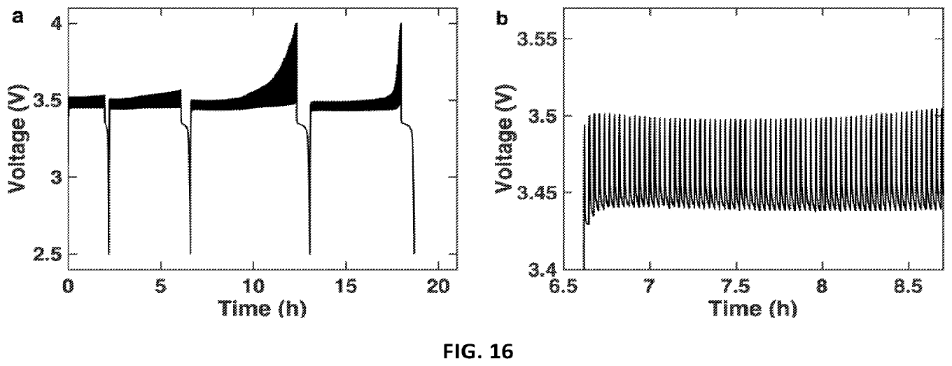

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this specification will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term are the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, as used in the description herein and throughout the claims that follow, the meaning of “a”, “an”, and “the” includes plural reference unless the context clearly dictates otherwise. Also, it will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation depicted in the figures. For example, if the device in one of the figures. is turned over, elements described as being on the “lower” side of other elements would then be oriented on “upper” sides of the other elements. The exemplary term “lower”, can, therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be further understood that the terms “comprises” and/or “comprising,” or “includes” and/or “including” or “has” and/or “having”, or “carry” and/or “carrying,” or “contain” and/or “containing,” or “involve” and/or “involving, and the like are to be open-ended, i.e., to mean including but not limited to. When used in this specification, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification, and will not be interpreted in an idealized or overly formal sense unless expressly so defined herein.

As used in this specification, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated.

As used in this specification, the phrase “at least one of A, B, and C” should be construed to mean a logical (A or B or C), using a non-exclusive logical OR. As used herein, the term “and/or” includes any and all combinations of one or more of the associated listed items.

The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in a different order (or concurrently) without altering the principles of the invention.

Solid-state electrolytes (SSEs) have attracted significant attention for rechargeable lithium-ion batteries due to their potential for enabling lithium metal anodes with higher energy densities and for improving safety by removing volatile liquid electrolytes. However, existing solid-state electrolyte materials lack sufficient electrochemical performance or require expensive and time-consuming processing methods, thus preventing their widescale adoption.

Recent efforts have attempted to address the processing limitations of SSEs to enable their introduction into mass-produced lithium metal battery (LMB) applications. Specifically, it is necessary that the production of SSEs yields a thin layer (<50 μm) to maintain sufficiently high cell-level energy densities. Since blade coating is a widely used and well-understood additive manufacturing method that is currently used to produce lithium-ion batteries, it is of high interest to develop blade-coatable SSE slurries. Several reports have used blade coating to demonstrate its potential for SSE materials including polymer composites, sulfides, ceramics, and sol-gel ionogels. However, these reported examples possess one or more significant drawbacks such as poor room temperature ionic conductivity, energy and time intensive post-processing, or instability with lithium metal anodes, cathode electrode materials, or ambient air. In contrast, nanocomposite ionogels, including an ionic liquid and an inorganic nanomaterial, offer several advantages that can potentially resolve these issues. For example, prior work has shown that hexagonal boron nitride (hBN) nanoplatelets produced using a scalable liquid-phase exfoliation process are suitable ionogel matrix materials, resulting in excellent thermal stability, high ionic conductivity (>1 mS cm⁻¹), favorable mechanical modulus (>1 MPa), and a wide electrochemical stability window. Despite these advantages, a blade-coatable inorganic ionogel electrolyte without time-consuming in situ gel formation has not yet been reported.

In view of the aforementioned deficiencies and inadequacies, one of the objectives of this invention is to provide a hBN ionogel electrolyte that exhibits high ionic conductivity at room temperature (>1 mS cm⁻¹) and is stable against lithium metal anodes. In addition, the blade-coatable hBN ionogel slurry has a sufficiently low viscosity to enable its use in existing lithium-ion battery manufacturing infrastructure. This blade-coatable hBN ionogel can be applied over a wide area in a thin (<40 μm) and crack-free film that also provides high-quality interfacial contact with cathode composite electrodes. The resulting blade-coated hBN ionogel electrolyte is employed in a lithium metal battery with a LiFePO₄ (LFP) cathode, exhibiting excellent rate capability at both room temperature and 60° C. as well as 78% capacity retention after 500 cycles at a rate of 1C.

In one aspect of the invention, the ionogel comprises an ionic liquid electrolyte (ILE) comprising 1-ethyl-3-methyl-imidazolium bis(fluorosulfonyl)imide (EMIM-FSI) and lithium bis(fluorosulfonyl)imide (LiFSI) dissolved in the EMIM-FSI; and a solid matrix material comprising hexagonal boron nitride (hBN) nanoplatelets mixed with the ionic liquid electrolyte in at least one solvent.

In one embodiment, the EMIM-FSI has relatively low viscosity and high ionic conductivity of the imidazolium cation, while the FSI anion provides cathodic stability down to 0 V vs. Li/Li⁺.

In one embodiment, the ILE has a high concentration of the LiFSI for enhancing the stability of lithium plating and generating a favorable LiF-rich solid electrolyte interface (SEI) with lithium metal.

In one embodiment, the ILE contains about 50 mol % of the LiFSI.

In one embodiment, the hBN nanoplatelets comprise exfoliated hBN nanoplatelets.

In one embodiment, each exfoliated hBN nanoplatelet is coated with a thin amorphous carbon coating.

In one embodiment, the hBN Nanoplatelets have desirable physical properties including thermal stability, chemical inertness, electrically insulating nature, and mechanical robustness. In one embodiment, the hBN nanoplatelets have the high surface area for generating strong interactions with the ILE, thereby confining the ILE and generating a high mechanical modulus gel that is greater than about 1 MPa.

In one embodiment, the at least one solvent is a polar solvent selected to create a well-mixed slurry and provide favorable thermodynamic properties for thermal removal.

In one embodiment, the ionogel has a viscosity that is tunable by the at least one solvent. In one embodiment, the at least one solvent is adapted to tune the viscosity of the ionogel to match that of existing commercial blade coating slurries used in high-throughput coating equipment. The viscosity of existing commercial blade coating slurries is about 10⁴ cP at a shear rate of 100 s⁻¹.

In one embodiment, the at least one solvent is operably removable with a thermal treatment.

In one embodiment, the at least one solvent comprises N,N-dimethylformamide (DMF), diglyme, N-methyl-pyrrolidone, or 1,4-dioxane.

In one embodiment, the ionogel has about 15-25 wt % of the hBN nanoplatelets, about 25-35 wt % of the ILE, and more than 50 wt % of the at least one solvent.

In one embodiment, the ionogel is a blade-coatable ionogel that is capable of forming a blade-coated film having a thickness of less than about 40 μm with crack-free without use of a polymeric binder.

In one embodiment, the ionogel is coatable directly onto a composite cathode, and providing excellent interfacial contact with low impedance.

In one embodiment, the blade-coated film is a blade-coated solid-state electrolyte (SSE) film for a lithium metal battery (LMB).

In one embodiment, the SSE film has sufficient mechanical stiffness to inhibit growth of lithium dendrites with a storage modulus of greater than about 1 MPa, while also provides excellent interfacial contact to the composite cathode and a lithium metal anode.

In one embodiment, the SSE film is electrochemically stable against lithium metal enabling its utilization in LFP|Li cells that can be cycled at 1C rate with an about 78% capacity retention after about 500 cycles at room temperature.

In one embodiment, the thermal stability of the hBN nanoplatelets and the ILE allows for operation of LFP|Li cells at about 60° C. with an about 33% improvement in gravimetric capacity at 1C compared to room temperature.

In one embodiment, ionic conductivity of the ionogel remains high with values of about 1.6 mS cm⁻¹ and about 5.5 mS cm⁻¹ at room temperature and about 60° C., respectively.

In another aspect of the invention, the ionogel comprises an ionic liquid electrolyte (ILE); and a solid matrix material mixed with the ionic liquid electrolyte.

In one embodiment, the ILE comprises an ionic liquid comprising at least one of 1-ethyl-3-methyl-imidazolium bis(fluorosulfonyl)imide (EMIM-FSI), 1-ethyl-3-methyl-imidazolium bis(trifluoromethylsulfonyl)imide (EMIM-TFSI), N-methyl-N-propylpyrrolidinium bis(trifluoromethylsulfonyl)imide (Py₁₃-TFSI), and N-methyl-N-propylpyrrolidinium bis(fluorosulfonyl)imide (Py₁₃-TFSI), or a combination of the ionic liquid along with an lithium salt comprising at least one of lithium bis(fluorosulfonyl)imide (LiFSI), lithium bis(trifluoromethylsulfonyl)imide (LiTFSI), and lithium bis(oxalato) borate (LiBOB), or a combination of the lithium salt dissolved in the ionic liquid.

In one embodiment, the solid matrix material is selected to have desirable physical properties including thermal stability, chemical inertness, electrically insulating nature, and mechanical robustness.

In one embodiment, the solid matrix material comprises boron nitride nanosheets (BNNS), borocarbonitrides (BCN), oxide nanosheets, layered perovskites, hydroxide nanosheets including hydrotalcite-like layered double hydroxides, natural clays including bentonites and montmorillonites, or a combination of them.

In one embodiment, the oxide nanosheets comprise Al₂O₃, TiO₂ (anatase and rutile), ZrO₂, Nb₂O₅, HfO₂, CaCu₃Ti₄O₁₂, Pb(Zr,Ti)O₃, (Pb,La)(Zr,Ti)O₃, SiO₂, Al₂O₃, HfSiO₄, ZrO₂, HfO₂, Ta₂O₅, La₂O₃, LaALO₃, Nb₂O₅, BaTiO₃, SrTiO₃, Ta₂O₅, or a combination of them.

In one embodiment, the BNNS comprises hexagonal boron nitride (hBN) nanoplatelets.

In one embodiment, the hBN nanoplatelets comprise exfoliated hBN nanoplatelets.

In one embodiment, each exfoliated hBN nanoplatelet is coated with a thin amorphous carbon coating.

In one embodiment, the solid matrix material is mixed with the ionic liquid electrolyte in at least one solvent.

In one embodiment, the at least one solvent is a polar solvent selected to create a well-mixed slurry as well as provide favorable thermodynamic properties for thermal removal.

In one embodiment, the ionogel has a viscosity that is tunable by the at least one solvent.

In one embodiment, the at least one solvent is adapted to tune the viscosity of the ionogel to match that of existing commercial blade coating slurries used in high-throughput coating equipment. The viscosity of existing commercial blade coating slurries is about 10⁴ cP at a shear rate of 100 s⁻¹.

In one embodiment, the at least one solvent is operably removable with a thermal treatment.

In one embodiment, the at least one solvent comprises N,N-dimethylformamide (DMF), diglyme, N-methyl-pyrrolidone, or 1,4-dioxane.

In one embodiment, the ionogel is a blade-coatable ionogel that is capable of forming a blade-coated film having a thickness of less than about 40 μm with crack-free without use of a polymeric binder.

In one embodiment, the ionogel is coatable directly onto a composite cathode, and providing excellent interfacial contact with low impedance.

In one embodiment, the blade-coated film is a blade-coated solid-state electrolyte (SSE) film for a lithium metal battery (LMB).

In one embodiment, the SSE film has sufficient mechanical stiffness to inhibit growth of lithium dendrites with a storage modulus of greater than about 1 MPa, while also provides excellent interfacial contact to the composite cathode and a lithium metal anode.

In one embodiment, the SSE film is electrochemically stable against lithium metal enabling its utilization in LFP|Li cells that can be cycled at 1C rate with an about 78% capacity retention after about 500 cycles at room temperature.

In one embodiment, the thermal stability of the hBN nanoplatelets and the ILE allows for operation of LFP|Li cells at about 60° C. with an about 33% improvement in gravimetric capacity at 1C compared to room temperature.

In one embodiment, ionic conductivity of the ionogel remains high with values of about 1.6 mS cm⁻¹ and about 5.5 mS cm⁻¹ at room temperature and about 60° C., respectively.

In one embodiment, the ionogel has about 15-25 wt % of the solid matrix material, about 25-35 wt % of the ILE, and more than 50 wt % of the at least one solvent.

In yet another aspect, the invention relates to a device comprising one or more components formed of the ionogel as disclosed above.

In one embodiment, the device is one or more batteries, one or more supercapacitors, or any combination of them.

In a further aspect, the invention relates to a method for forming an ionogel, comprising providing an ionic liquid electrolyte (ILE) and a solid matrix material; and mixing the solid matrix material with the ILE in at least one solvent.

In one embodiment, the ILE comprises an ionic liquid comprising at least one of 1-ethyl-3-methyl-imidazolium bis(fluorosulfonyl)imide (EMIM-FSI), 1-ethyl-3-methyl-imidazolium bis(trifluoromethylsulfonyl)imide (EMIM-TFSI), N-methyl-N-propylpyrrolidinium bis(trifluoromethylsulfonyl)imide (Py₁₃-TFSI), and N-methyl-N-propylpyrrolidinium bis(fluorosulfonyl)imide (Py₁₃-TFSI), or a combination of the ionic liquid along with an lithium salt comprising at least one of lithium bis(fluorosulfonyl)imide (LiFSI), lithium bis(trifluoromethylsulfonyl)imide (LiTFSI), and lithium bis(oxalato) borate (LiBOB), or a combination of the lithium salt dissolved in the ionic liquid.

In one embodiment, the solid matrix material is selected to have desirable physical properties including thermal stability, chemical inertness, electrically insulating nature, and mechanical robustness.

In one embodiment, the solid matrix material comprises boron nitride nanosheets (BNNS), borocarbonitrides (BCN), oxide nanosheets, layered perovskites, hydroxide nanosheets including hydrotalcite-like layered double hydroxides, natural clays including bentonites and montmorillonites, or a combination of them.

In one embodiment, the oxide nanosheets comprise Al₂O₃, TiO₂ (anatase and rutile), ZrO₂, Nb₂O₅, HfO₂, CaCu₃Ti₄O₁₂, Pb(Zr,Ti)O₃, (Pb,La)(Zr,Ti)O₃, SiO₂, Al₂O₃, HfSiO₄, ZrO₂, HfO₂, Ta₂O₅, La₂O₃, LaALO₃, Nb₂O₅, BaTiO₃, SrTiO₃, Ta₂O₅, or a combination of them.

In one embodiment, the BNNS comprises hexagonal boron nitride (hBN) nanoplatelets that are obtained by shear-mixing bulk hBN microparticles in ethanol with ethyl cellulose (EC) acting as a dispersing agent to form a shear-mixed dispersion; separating the exfoliated hBN nanoplatelets and EC from the shear-mixed dispersion by centrifuge-assisted sedimentation and flocculation; and collecting hBN/EC solids; and heating the collected hBN/EC solids at a temperature for a period of time to decompose the EC, thereby volatilizing most of the EC, but also leaving behind a thin amorphous carbon coating on the surface of each of the exfoliated hBN nanoplatelets, which contributes to enhanced interactions between the hBN nanoplatelets and the ionic liquids for stronger solidification of the ionogel ink.

In one embodiment, the temperature is about 300-500° C., and the period of time is for about 2-4 hours.

In one embodiment, the ionogel have a viscosity that is tunable by the at least one solvent.

In one embodiment, the at least one solvent is adapted to tune the viscosity of the ionogel to match that of existing commercial blade coating slurries used in high-throughput coating equipment.

In one embodiment, the at least one solvent is operably removable with a thermal treatment.

In one embodiment, the at least one solvent comprises N,N-dimethylformamide (DMF), diglyme, N-methyl-pyrrolidone, or 1,4-dioxane.

According to the invention, the use of blade-coatable ionogels enables both processability via the formulation of a blade-coatable slurry and cell performance by maintaining high ionic conductivity. This combination of attributes enables lithium-ion battery cells with high energy density that can be produced with existing manufacturing equipment and processes.

The invention has, among other things, the following beneficial and advantageous effects:

To satisfy the increasing demand for higher energy densities, substantial effort has been devoted to utilizing lithium-ion battery anode and cathode materials with higher specific capacity. The lithium metal anode is foremost amongst potential options with an order of magnitude higher specific capacity than incumbent graphite anodes. However, conventional liquid electrolytes are unstable against lithium metal anodes resulting in poor cycling efficiency and dendritic lithium growth that can lead to short circuits and catastrophic cell failure. Moreover, the high flammability of organic solvents poses serious safety concerns when short circuits do occur due to resulting cell heating and subsequent thermal runaway reactions that lead to fire hazards. To overcome these issues, significant attention has been directed toward the development of solid-state electrolytes as a replacement for liquid electrolytes. Although considerable progress has been achieved, solid-state electrolytes based on inorganics and polymers continue to face important challenges in practical applications, including low ionic conductivity, high interfacial resistance, and cumbersome processing.

Ionogels are solid-state electrolytes based on ionic liquids and gelling matrices. In contrast to traditional liquid electrolytes, ionic liquids offer nonflammability, negligible vapor pressure, and high thermal stability, which not only addresses safety concerns but also elevates the high-temperature limit of battery operation. Furthermore, the electrochemical stability window of the electrolyte can be tuned based on judicious choice of ionic liquid, including stability with a lithium metal anode. Moreover, ionogel electrolytes provide high ionic conductivity, favorable interfacial contact with electrodes, and wide processing compatibility, which address the key issues confronting inorganic and polymer solid-state electrolytes.

Blade-coating is a commonly utilized high-throughput manufacturing method in modern production of lithium-ion battery technologies. Using such a platform could help reduce the processing costs of implementing solid-state electrolytes. Traditionally, a solvent is used to suspend the desired material during the coating process, which is then later evaporated leaving a clean film. Solid-state electrolyte technologies such as ceramics and sulfides can be applied through blade coating, but require the use of a polymeric binder to prevent film cracking. Ionogels, however, can be blade-coated without the need for a binder, which prevents the dilution of ionically conducting pathways for lithium transport. Moreover, blade-coatable ionogels enable the scalable application of solid-state electrolytes in thin and continuous layers, thus enabling high energy density solid-state lithium metal batteries.

Other production methods have been demonstrated for thin solid-state electrolytes. Blade-coating using a scaffold material or a polymer binder has been completed to prevent the final film from cracking or delaminating from the substrate. This approach results in a dilution of the ionically conductive pathways and thus effectively reduces the rate of lithium transport. Approaches such as 3D printing, hot pressing and in situ polymerization have also been demonstrated, but these methods currently lack commercial applicability at the throughput necessary to economically competitive.

The invention may find widespread applications in solid-state batteries, lithium-ion batteries, supercapacitors, transistors, neuromorphic computing devices, flexible electronics, printed electronics, and so on.

These and other aspects of the invention are further described below. Without intent to limit the scope of the invention, exemplary instruments, apparatus, methods, and their related results according to the embodiments of the invention are given below. Note that titles or subtitles may be used in the examples for convenience of a reader, which in no way should limit the scope of the invention. Moreover, certain theories are proposed and disclosed herein; however, in no way they, whether they are right or wrong, should limit the scope of the invention so long as the invention is practiced according to the invention without regard for any particular theory or scheme of action.

### Example

### Blade-Coatable Hexagonal Boron Nitride Ionogel Electrolytes for Scalable Production of Lithium Metal Batteries

Solid-state electrolytes (SSEs) have attracted significant attention for rechargeable lithium-ion batteries due to their potential to enable higher energy density technologies and improve cell safety by removing volatile liquid electrolytes. However, existing solid-state electrolytes materials lack sufficient electrochemical performance or require expensive and time-consuming processing methods that have prevented their widescale adoption.

In view of the above deficiencies and inadequacies, this exemplary study discloses a blade-coatable hexagonal boron nitride ionogel electrolyte that exhibits high room temperature ionic conductivity (>1 mS cm⁻¹), and is stable against lithium metal anodes, and can be applied over a wide area in a thin (<40 μm) and crack-free film. Furthermore, this blade-coatable slurry has a tunable viscosity to enable its use in existing battery manufacturing infrastructure. The resulting blade-coated hBN ionogel electrolyte is employed in a lithium metal battery with a LiFePO₄ cathode, exhibiting superlative rate capability at room temperature with a 78% capacity retention after 500 cycles at a rate of 1C.

### Methods

Exfoliation of hBN Nanoplatelets: Liquid phase exfoliation was used to produce hBN nanoplatelets from bulk micron-sized hBN particles using a previously reported method. Briefly, bulk hBN particles (120 g, 1 μm, 98%, Sigma-Aldrich) were combined with ethanol (800 mL, 200 proof, Fisher Scientific) and ethyl cellulose (12 g, 4 cP viscosity grade, Sigma-Aldrich) as a dispersing agent. The mixture was shear mixed at 10,230 RPM for 2 h using a stator/rotor mixer (LMA-5, Silverson Machines) with a square hole, high shear, stator screen. After shear mixing was complete, the mixture was centrifuged (J-26 XPI, Beckman Coulter) at 4,000 RPM (rₘₐₓ=3,000 g) for 20 min. The supernatant was collected and mixed with an aqueous sodium chloride solution (40 mg mL⁻¹) at a ratio of 16:9 by weight to flocculate the hBN nanoplatelets after which the solution was centrifuged at 7500 RPM (rₘₐₓ=10,400 g) for 6 min. The sedimented hBN nanoplatelets were then washed three times with deionized water to remove residual sodium chloride and dried at 120° C. for 24 h in a convection oven. The resulting powder was ground using a mortar and pestle and then annealed at 400° C. for 4 h in air to decompose the remaining ethyl cellulose, leaving an amorphous carbon coating on the surface of the hBN particles.

Formulation of hBN Ionogel Slurry: To produce the ionic liquid electrolyte (ILE) used in the hBN ionogel slurry, 3.5 M (50 mol %) lithium bis(fluorosulfonyl)imide (LiFSI) salt (99.9%, 20 ppm H₂O max, Solvionic) was dissolved in 1-ethyl-3-methyl-imidazolium bis(fluorosulfonyl)imide (EMIM-FSI)(99.9%, 20 ppm H₂O max, Solvionic) by stirring with a magnetic stir bar at 60° C. for 16 h. In a typical slurry batch, hBN nanoplatelets (0.333 g), ILE (0.667 g), and N,N-dimethylformamide (DMF)(1.00 g, 99.8%, anhydrous, Sigma-Aldrich) were placed in a 12 mL mixing cup along with 3 zirconia mixing balls (5 mm diameter). The slurry was then homogenized in a centrifugal mixer (ARE-310, Thinky) at increasing speeds up to 2,000 RPM for a total of 20 min. The resulting slurry was then stored in an argon environment at room temperature.

Characterization of Blade-Coated hBN Ionogel and Slurry: Micrographs of the hBN nanoplatelets, hBN ionogel, and cross-section of an LFP|hBN ionogel|Li cell stack were taken using a scanning electron microscope (Hitachi, SU8030). Rheology of the hBN ionogel slurry was measured using a rheometer (MCR 302, Anton Parr) at 25° C. The slurry viscosity was determined using a 25 mm parallel plate geometry with gap of 0.5 mm and a shear rate from 10-1 to 103 s⁻¹. The viscoelastic properties of the hBN ionogel were determined using an 8 mm parallel plate geometry with a 1 mm gap, a strain of 0.1%, and a reciprocating range of 10-1 to 102 Hz. The thermal stability of the hBN ionogel slurry was measured using a thermogravimetric analyzer (TGA/DSC 3+, Mettler-Toledo) under a nitrogen environment by sweeping the temperature from 25° C. to 600° C. at a rate of 10° C. min-1. Measurement of the residual diluent solvent was performed using an FTIR spectrometer (Nexus 870, Thermo-Nicolet) and observing the peak height of the DMF carbonyl stretch at 1670 cm⁻¹. Calibration samples for FTIR analysis were prepared by centrifugal mixing the hBN ionogel with set amounts of DMF or by dry mixing the ionogel (i.e., no DMF) with a mortar and pestle. The dried sample for FTIR was produced by blade coating the hBN ionogel slurry onto a glass slide and then drying on a hotplate at 160° C. for 30 min. The dry thickness of the blade-coated hBN ionogel was measured with a laser profilometer (LEXT OLS5100, Olympus). LFP cathode discs (10 mm diameter) were secured to a glass slide, and their height profiles were measured before blade coating and drying (160° C., 30 min) the hBN ionogel slurry at various blade settings. The height profile of the resulting LFP|ionogel sample was then measured, allowing the height of the hBN ionogel film to be determined.

Electrode Preparation: To prepare the LFP cathode, LiFePO₄ (EQ-Lib-LFPO-S21), carbon black (EQ-Lib-SuperC45), and PVDF (EQ-Lib-PVDF) were sourced from MTI Corporation. These cathode components were then centrifugally mixed into a slurry with NMP at a ratio of 85:10:5. The cathode slurry was then blade coated onto a carbon-coated aluminum foil (EQ-CC-A1-18u-260, MTI) using an adjustable applicator knife (EQ-Se-KTQ-250A, MTI) and an automatic film coater (MSK-AFA-III, MTI) at a speed of 20 cm s⁻¹. The coated aluminum was then dried at 120° C. for 30 min followed by vacuum annealing at 80° C. for 12 h. The dried electrode sheets were cut into 10 mm diameter discs and calendared through a gap of 40 μm. The active material loading for the LFP cathodes was about 3.2 mg cm⁻² equating to 0.48 mAh cm⁻². The lithium metal used as the anode consisted of 12.7 mm diameter discs (99.9% trace metal basis, Sigma-Aldrich) with a thickness of 375 μm.

Electrochemical Characterization: The ionic conductivity (6) of the hBN ionogel was measured using coin cells (CR2032) in a stainless-steel (SS)|ionogel|SS geometry using the following equation,

$$σ = \frac{t}{R \times A} ,$$

where t and A are the thickness and cross-sectional area, respectively, of the hBN ionogel sample between the SS electrodes, and R represents the bulk resistance as measured by EIS. All EIS was performed with a potentiostat (VSP, BioLogic) using a frequency range of 1 MHz to 100 mHz and an amplitude of 10 mV. Variable temperature measurements were performed using an environmental chamber (BTX-475, Espec). Electrochemical stability was measured with LSV or CV using the potentiostat with lithium metal as the reference electrode and SS or LFP as the working electrode, all with a scan rate of 1 mV^{s-1}. Interfacial impedance was measured with EIS using an LFP|Li cell with the hBN ionogel electrolyte blade coated or manually deposited via spatula and razor blade. Before measuring EIS, both sets of cells underwent one charge and discharge cycle at 0.1C between 2.5 V and 4.0 V before being charged to 50% state of charge. The interfacial impedance was extracted using equivalent circuit modeling.

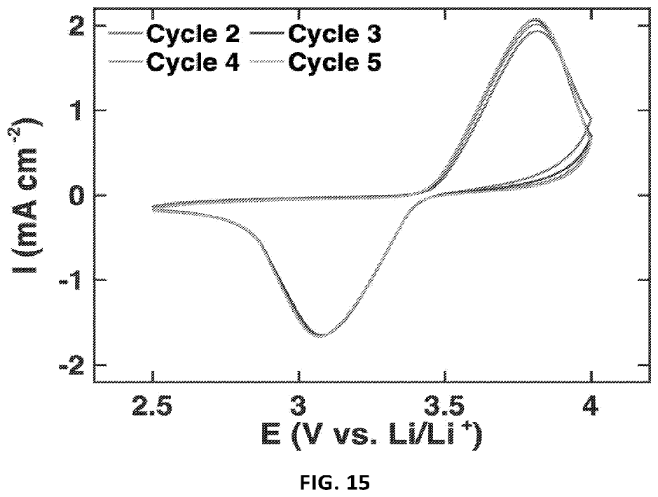

Battery Testing: The hBN ionogel slurry was applied to LFP cathode discs via blade coating using a film applicator with an adjustable micrometer (EQ-Se-KTQ-50, MTI) and then dried on a hot plate at 160° C. for 30 min. Once dried, the LFPionogel disc was assembled with a lithium metal anode inside of a CR2032 coin cell. All hBN ionogel slurry blade coating and cell construction occurred inside of an argon-filled glovebox. All galvanostatic cycling was performed using a constant current (CC) mode of operation with a battery testing system (BT-2143, Arbin) at room temperature (22° C.) or elevated temperature (60° C.). All LFP|Li cells were cycled between 2.5 V and 4.0 V. Cells undergoing testing for rate capability were tested as assembled with no pre-conditioning where 1C=150 mA/g. Cells undergoing long-term cycling stability testing were pre-conditioned for 4 cycles using a pulsed charging method (1C charge 15 s on/90 s off, 1C constant-current discharge) with an increasing charge capacity limit for the first three cycles (FIG. 15). At an ionogel thickness of 40 μm, approximately 5.5 mg of electrolyte was used over the 10 mm diameter cathode. For the LFP cathodes used in this work, these values equate to an electrolyte: LFP mass ratio of about 2.2.

### Results and Discussion

In the formulation of an hBN ionogel slurry that yields a thin (<40 μm) blade-coated SSE, a carefully selected diluent solvent (i.e., N,N-dimethylformamide (DMF)) is used to reduce the viscosity of the ionogel to match that of existing commercial blade coating slurries used in high-throughput coating equipment. The resulting slurry can be coated directly onto cathode composite electrodes, providing excellent interfacial contact with low impedance. Subsequently, after the diluent solvent is thermally removed, the thin hBN ionogel layer is free of cracks without the use of a polymeric binder, thus maintaining high ionic conductivity and mechanical modulus. These superlative properties are used to demonstrate best-in-class LMB rate capability and cycle stability using a LiFePO₄ (LFP) cathode at room temperature.

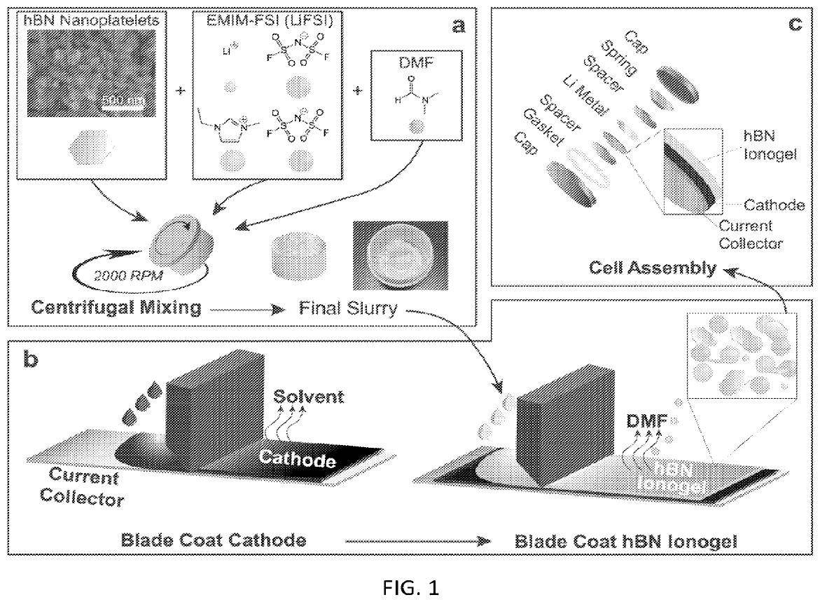

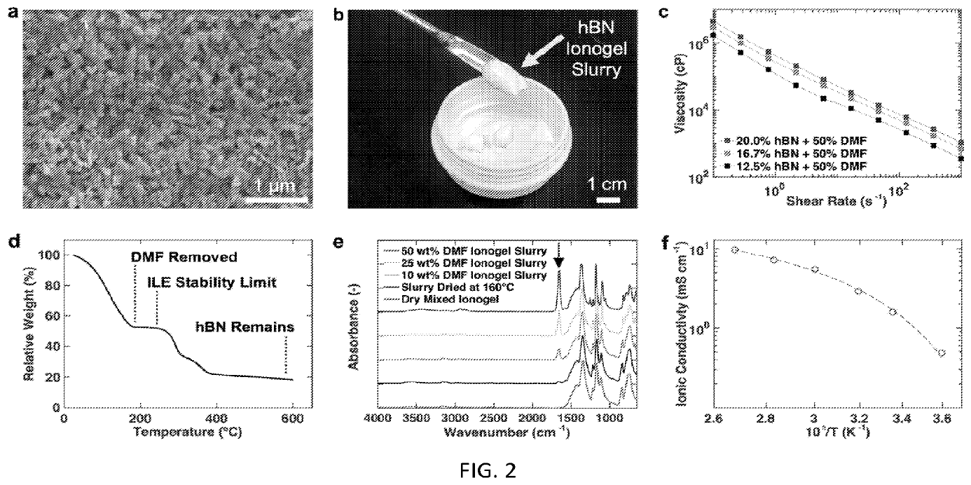

FIG. 1 displays a schematic of the hBN ionogel slurry preparation, application, drying, and application in an LMB. The slurry including hBN nanoplatelets (16.7 wt %), an ionic liquid electrolyte (ILE, 33.3 wt %), and diluent solvent (50 wt %) was prepared via centrifugal mixing to fully homogenize the slurry. The ILE used in the slurry was 1-ethyl-3-methyl-imidazolium bis(fluorosulfonyl)imide (EMIM-FSI) containing 3.5 M (50 mol %) lithium bis(fluorosulfonyl)imide (LiFSI) salt. EMIM-FSI was chosen due to the relatively low viscosity and high ionic conductivity of the imidazolium cation, while the FSI anion has been shown to provide cathodic stability down to 0 V vs. Li/Li⁺. Furthermore, a high concentration of LiFSI within an ILE enhances the stability of lithium plating and generates a favorable LiF-rich solid electrolyte interface (SEI) with lithium metal. Nanoplatelets of hBN (pane a of FIG. 2), prepared by scalable liquid-phase exfoliation, were used as the gelling matrix due to their desirable physical properties including thermal stability, chemical inertness, electrically insulating nature, and mechanical robustness. Moreover, the high surface area of the hBN nanoplatelets generates strong interactions with the ILE, thus confining the ionic liquid and generating a high mechanical modulus gel (>1 MPa).

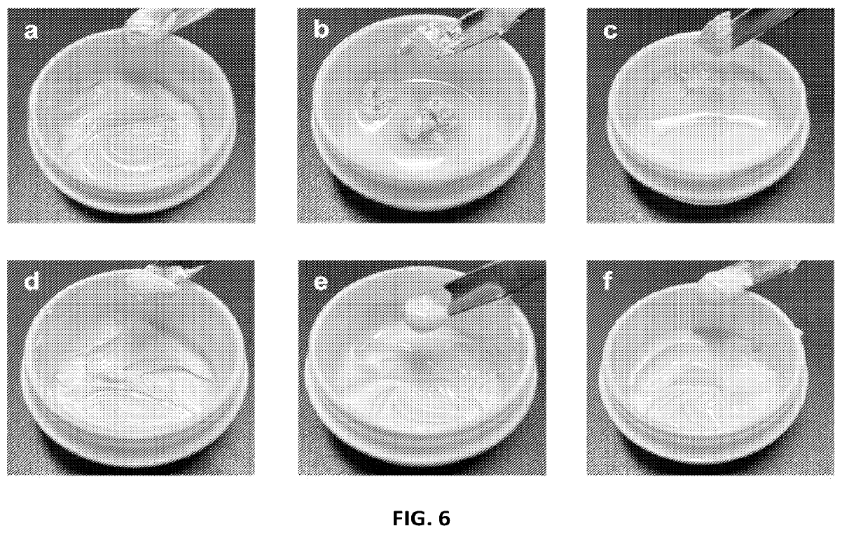

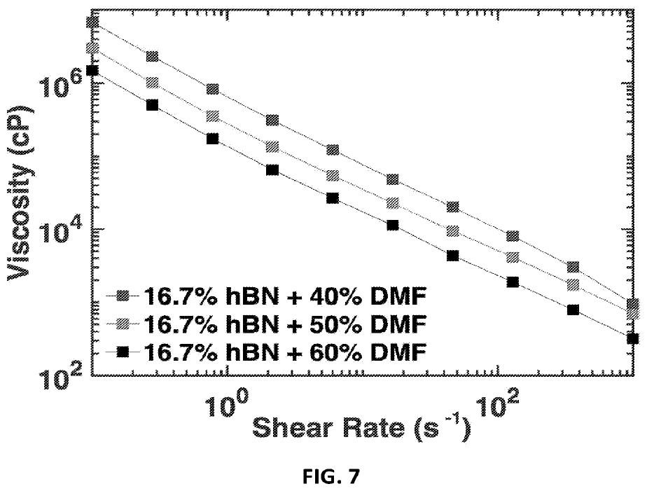

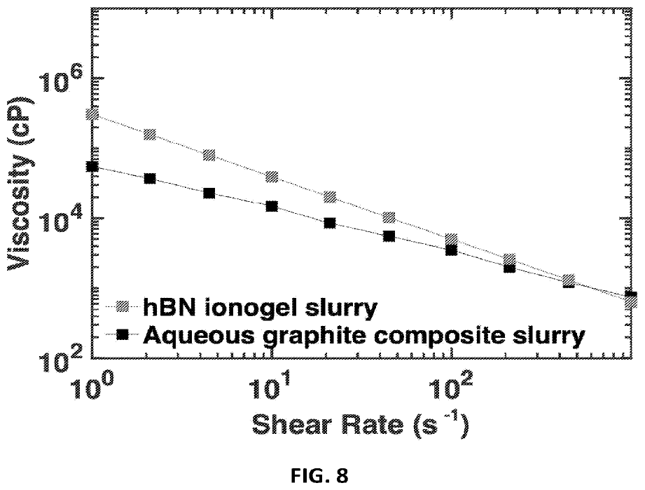

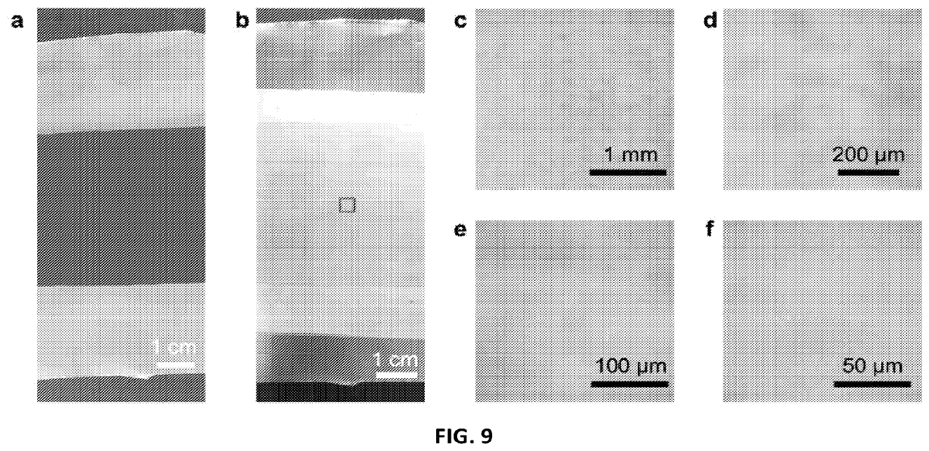

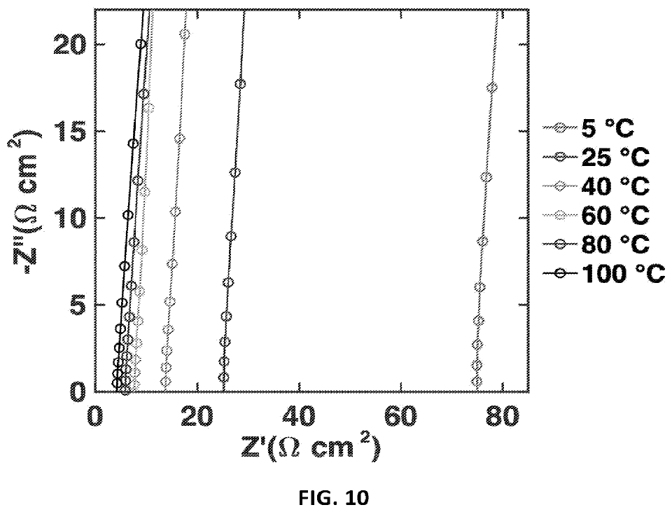

The diluent solvent used in the slurry must be sufficiently polar to create a well-mixed slurry (FIG. 6) as well as provide favorable thermodynamic properties for thermal removal. DMF possesses sufficient polarity to mix and disperse the hBN ionogel (panel b of FIG. 2 and panel a of FIG. 6), whereas non-polar solvents such as heptane and toluene (panels b-c of FIG. 6) are ineffective. Moreover, non-polar solvents are immiscible with the ILE, creating phase separation between the ionogel and diluent solvent. The attributes of DMF allow for a range of slurry viscosities that are tuned based on the relative content of the hBN gelling matrix (panel c of FIG. 2) and diluent solvent (FIG. 7). If the hBN loading is fixed at 16.7 wt %, FIG. 8 shows that the viscosity of the hBN ionogel slurry can be tuned with the diluent solvent (50 wt % DMF) to match that of commercial cathode composite slurries, especially at the high shear rates that are relevant to the rapid coating conditions used in existing lithium-ion battery manufacturing infrastructure. Furthermore, an additional advantage of DMF is its boiling point (T_{b}=153° C.), which is sufficiently high to prevent undesired excess evaporation at room temperature (unlike 1,4-dioxane (T_{b}=101° C.) shown in panel d of FIG. 6), but still well below the thermal degradation limit of the ILE. Panel d of FIG. 2 presents the thermogravimetric analysis (TGA) of the hBN ionogel slurry, which shows that DMF is fully removed at about 170° C., prior to the onset of thermal degradation of EMIM-FSI and LiFSI at about 225° C., above which only the hBN nanoplatelets remain intact. Other polar solvents such as N-methyl-pyrrolidone (NMP)(T_{b}=202° C.) or ethyl lactate (EL)(T_{b}=154° C.) also mix well with the hBN ionogel (FIGS. 6e,6f). However, the boiling point of NMP is excessively high for efficient thermal removal, while EL is a protic solvent that reacts rapidly with lithium metal anodes. Fourier transform infrared (FTIR) spectroscopy can be used to measure the residual DMF in the resulting hBN ionogel after thermal drying (panel e of FIG. 2). Heating the coated slurry at 160° C. for 30 min is sufficient to remove >99% of the diluent solvent as calculated using the peak height for the DMF carbonyl stretch at 1670 cm⁻¹. This rapid removal of the diluent solvent occurs without the introduction of additional FTIR peaks, suggesting the absence of degradation products. The final blade-coated hBN ionogel (33.4 wt % hBN) maintains both a high room temperature ionic conductivity of 1.6 mS cm⁻¹ (panel f of FIG. 2 and FIG. 9) and desirable mechanical properties such as a high mechanical modulus exceeding 1 MPa (FIG. 10).

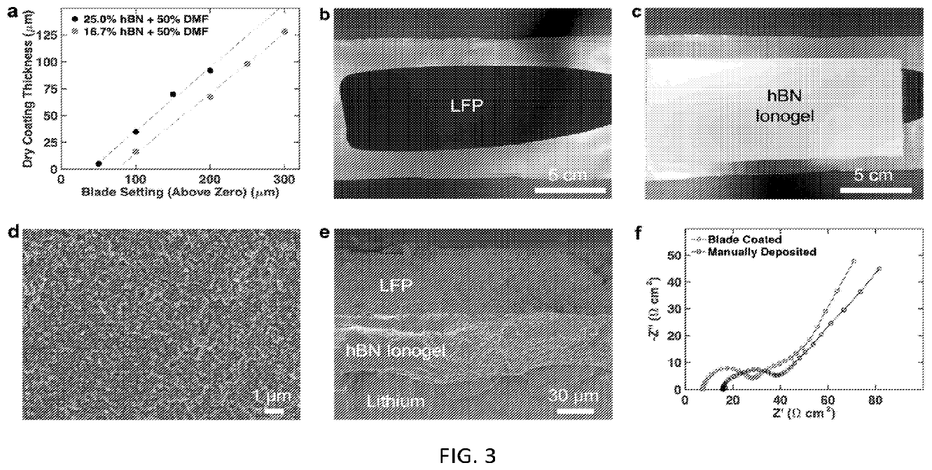

To ensure that a blade-coated SSE is viable for LMB applications, the material must produce a high-quality film with controllable thickness. To investigate the blade-coating performance of the formulated hBN ionogel slurry, the final thickness of the hBN ionogel films was measured using laser profilometry for various blade settings. The resulting calibration curve (panel a of FIG. 3) shows a linear response between the blade setting and final coating thickness over the range of 5-125 μm. Panels b-c of FIG. 3 display images of a blade-coated LFP cathode composite on an aluminum current collector before and after blade coating of the hBN ionogel. The dried hBN ionogel is crack-free over large areas without the use of a polymeric binder, which is a key advantage since the use of a polymeric binder would compromise the thermal stability of the SSE in addition to diluting the percolating network of the high ionic conductivity ILE and thus decreasing ionic conductivity. The crack-free ionogel film can be attributed to the confinement of the ILE by the hBN nanoplatelets as shown by SEM (panel d of FIG. 3). This confinement results in the viscoelastic nature of the film, allowing it to accommodate the removal of the diluent solvent.

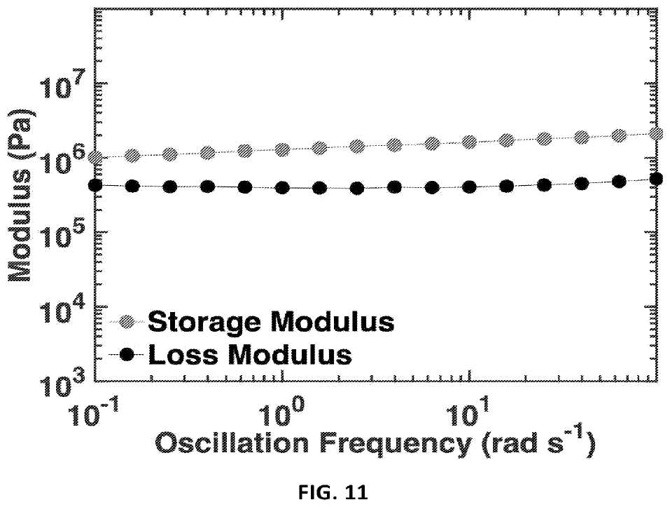

The final thickness and interfacial impedance of the blade-coated hBN ionogel were investigated since these parameters determine the energy density and rate performance of LMB cells. A cross-sectional SEM micrograph of a blade-coated LFP|ionogel|Li cell stack is provided in panel e of FIG. 3. This image shows that the final thickness of the blade-coated hBN ionogel is about 40 μm, which is within the desired regime for thin SSE films in high energy density LMB cells (<50 μm). Furthermore, excellent interfacial contact is observed between the hBN ionogel and the LFP cathode composite film. Similarly, the hBN ionogel film achieves high conformality with the lithium metal anode and its surface variations. Electrochemical impedance spectroscopy (EIS) was then used to quantify the interfacial impedance of an LFP|Li cell containing a blade-coated hBN ionogel film compared to an hBN ionogel layer manually deposited using a spatula and razor blade (panel f of FIG. 3). Equivalent circuit modeling of the EIS results (FIG. 11) reveals that the bulk resistance of the blade-coated ionogel is approximately half of the manually deposited version (9Ω cm² versus 19Ω cm²), which is consistent with the blade-coated film being significantly thinner (40 μm versus 300 μm). The superior interfacial contact of the blade-coated hBN ionogel also yields a 20% lower interfacial impedance compared to the manually deposited hBN ionogel, resulting in a lower overall cell impedance.

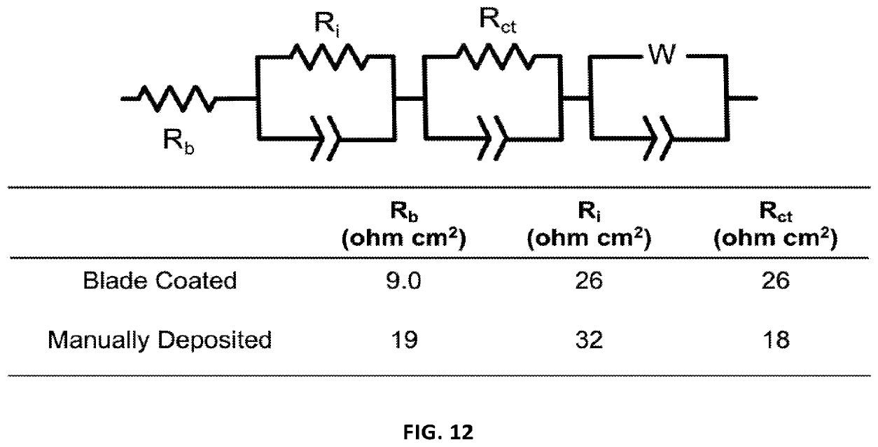

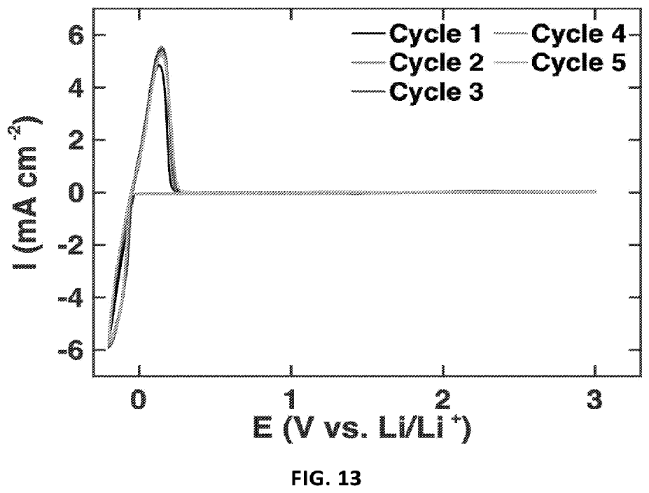

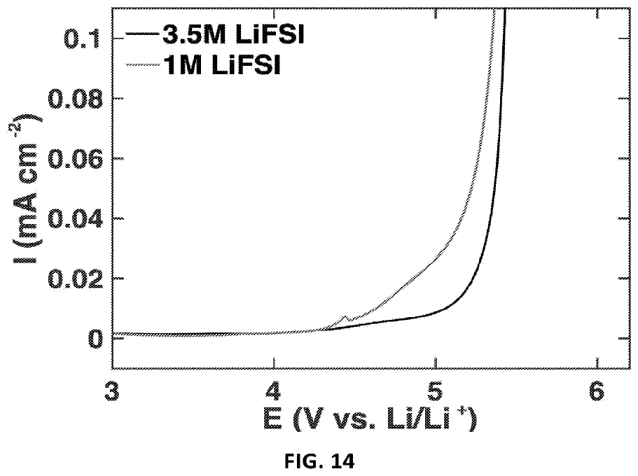

To confirm the electrochemical stability of the hBN ionogel against lithium metal, cyclic voltammetry (CV) was performed on stainless-steel (SS)|ionogel|Li cells between −0.2 V and 3.0 V vs. Li/Li⁺. The resulting voltammogram (FIG. 12) displays only one reversible anodic and cathodic peak pair that corresponds to lithium plating and stripping. Furthermore, negligible change in current density is observed over 5 cycles, indicating stability of the ILE with lithium metal, which is consistent with previous reports. Moreover, an additional advantage to the high-concentration ILE within the hBN ionogel is enhanced anodic stability. FIG. 13 shows the results of linear sweep voltammetry (LSV) from 3 V to 6 V vs. Li/Li⁺ using a SS|hBN ionogel|Li cell. The LSV curves compare hBN ionogels containing 3.5 M and 1 M LiFSI with the high concentration ILE exhibiting higher anodic stability (about 4.5 V vs. Li/Li⁺) compared to the reference sample, which matches previous reports of high-concentration electrolytes. Given the anodic stability limit of the hBN ionogel, it is well-suited to be paired with an LFP cathode within an LMB. Therefore, cyclic voltammetry was performed on an LFP|ionogel|Li cell between the voltage cutoffs of 2.5 V and 4.0 V. The resulting voltammogram (FIG. 14) displays a set of anodic and cathodic peaks representing lithiation and delithiation of the LFP with consistent peak current density after 5 cycles. This result further confirms the electrochemical stability of the blade-coated ionogel within an LFP|Li cell structure.

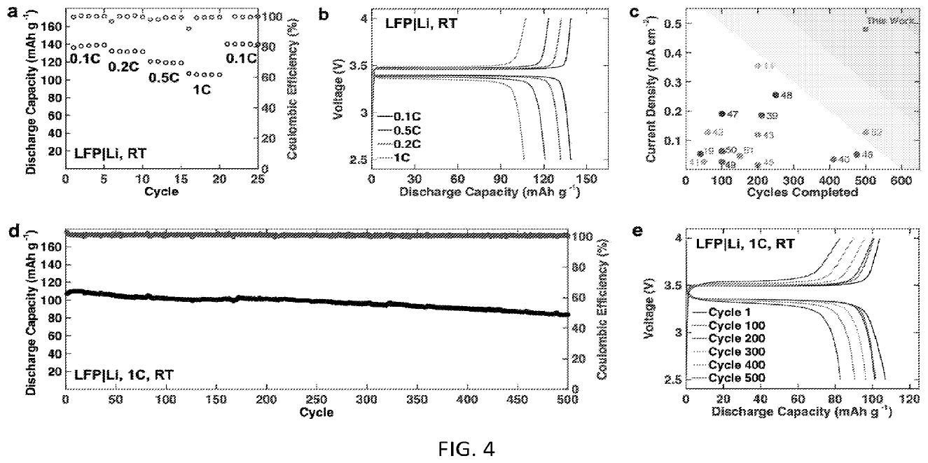

To test the cycling stability and rate performance of the blade-coated hBN ionogel, LFP|Li cells were constructed and galvanostatically cycled at room temperature (FIG. 4). Panel a of FIG. 4 displays the rate test of the LFP|Li cells with the blade-coated hBN ionogel, which yields the expected gravimetric capacity of 140 mAh g⁻¹ at 0.1C and an excellent high-rate performance of 106 mAh g⁻¹ at 1C. The charge and discharge profiles at various C-rates are shown in panel b of FIG. 4, and the expected LFP voltage plateaus at about 3.45 V and about 3.39 V indicate stable electrochemical operation in the cell. To test the cycling stability of the blade-coated hBN ionogel, LFP|Li cells were cycled continuously at 1C (panels d-e of FIG. 4). After 500 cycles, the capacity retention was 78% with an average coulombic efficiency of >99.99%. Significantly, the long-term cycling stability test yielded no voltage fluctuations or short circuits due to lithium dendrites, thus confirming the dendrite resistance of the hBN ionogel. Furthermore, panel c of FIG. 4 compares this result with the cycling stability of recently published work using an LFP|Li structure, thin (<100 μm) SSE, and room temperature cycling. Evidently, the combination of high ionic conductivity and robust mechanical properties of the blade-coated hBN ionogel results in best-in-class cycling stability at the highest areal current density.

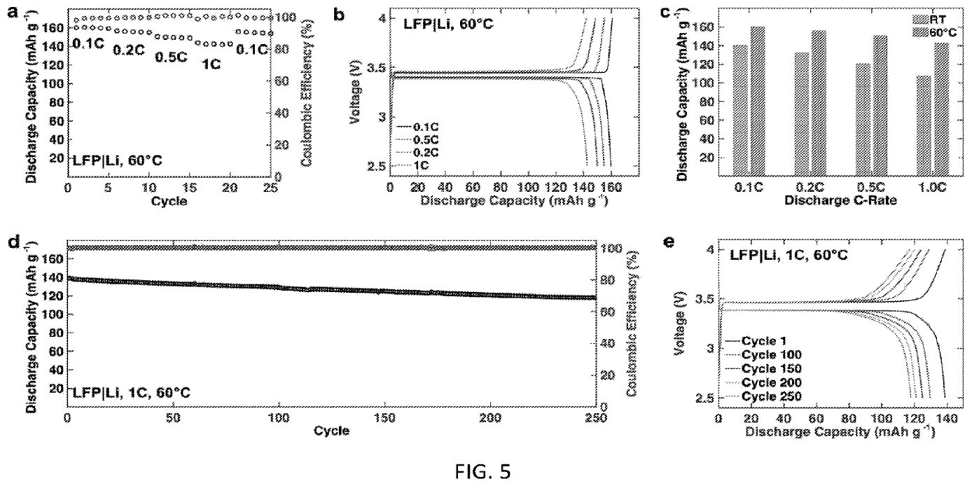

To demonstrate the thermal stability of the blade-coated hBN ionogel, the rate performance and cycling stability of LFP|Li cells were tested at an operating temperature of 60° C. (FIG. 5). Due to the increased ionic conductivity at elevated temperatures (panel f of FIG. 2) and further infiltration of the ILE into the LFP cathode, the achievable gravimetric capacity increased significantly to 160.5 mAh g⁻¹ at 0.1C and 142.7 mAh g⁻¹ at 1C, while maintaining an average coulombic efficiency >99.8%. These results represent an increase in gravimetric capacity of 14% and 33% at 0.1C and 1C, respectively. Furthermore, the charge and discharge plateaus are well-behaved, but exhibit reduced polarization, indicating a lower overpotential (panel b of FIG. 5) during high-temperature operation. The high-temperature cycling stability of the blade-coated hBN ionogel was tested through galvanostatic cycling of LFP|Li cells at 60° C. with a 1C charge and discharge rate (panels d-e of FIG. 5). The resulting capacity retention was 85% after 250 cycles with an average coulombic efficiency >99.9%. These attributes display the ability of the blade-coated hBN ionogel electrolyte to perform beyond the temperature limitations of traditional organic liquid electrolytes.

In conclusion, we have developed a blade-coatable hBN ionogel slurry that yields thin, conformal solid-state electrolyte films for high-performance LMBs. Compared to other potential SSE technologies, this platform allows for the use of existing lithium-ion battery manufacturing infrastructure without requiring expensive and time-intensive processing steps. Using a DMF diluent solvent, the viscosity of the hBN ionogel slurry can be tuned to match that of commercially-coated materials and only requires a brief thermal treatment to remove the solvent. The blade-coated hBN ionogel can be applied in a thin (<40 μm) and crack-free film, enabling the production of high energy density LMB cells. Additionally, the resulting hBN ionogel electrolyte has sufficient mechanical stiffness to inhibit the growth of lithium dendrites with a storage modulus >1 MPa, while also providing excellent interfacial contact to composite cathodes and lithium metal anodes. Beyond these favorable mechanical properties, the ionic conductivity of the hBN ionogel remains high with values of 1.6 mS cm⁻¹ and 5.5 mS cm⁻¹ at room temperature and 60° C., respectively. The resulting high-performance SSE is also electrochemically stable against lithium metal enabling its utilization in LFP|Li cells that can be cycled at 1C rate with a 78% capacity retention after 500 cycles at room temperature. Additionally, the thermal stability of the hBN nanoplatelets and ILE allows for operation of LFP|Li cells at 60° C. with a 33% improvement in gravimetric capacity at 1C compared to room temperature. Overall, this work establishes blade-coated hBN ionogels as an attractive and scalable option for LMB solid-state electrolytes.

To satisfy the increasing demand for higher energy densities, substantial effort has been devoted to utilizing lithium-ion battery anode and cathode materials with higher specific capacity. The lithium metal anode is foremost amongst potential options with an order of magnitude higher specific capacity than incumbent graphite anodes. However, conventional liquid electrolytes are unstable against lithium metal anodes resulting in poor cycling efficiency and dendritic lithium growth that can lead to short circuits and catastrophic cell failure. Moreover, the high flammability of organic solvents poses serious safety concerns when short circuits do occur due to resulting cell heating and subsequent thermal runaway reactions that lead to fire hazards. To overcome these issues, significant attention has been directed toward the development of solid-state electrolytes as a replacement for liquid electrolytes. Although considerable progress has been achieved, solid-state electrolytes based on inorganics and polymers continue to face important challenges in practical applications, including low ionic conductivity, high interfacial resistance, and cumbersome processing.

Blade-coating is a commonly utilized high-throughput manufacturing method in modern production of lithium-ion battery technologies. Using such a platform could help reduce the processing costs of implementing solid-state electrolytes. Traditionally, a solvent is used to suspend the desired material during the coating process, which is then later evaporated leaving a clean film. Solid-state electrolyte technologies such as ceramics and sulfides can be applied through blade coating, but require the use of a polymeric binder to prevent film cracking. The novel ionogels as disclosed herein, however, can be blade-coated without the need for a binder, which prevents the dilution of ionically conducting pathways for lithium transport. Moreover, blade-coatable ionogels enable the scalable application of solid-state electrolytes in thin and continuous layers, thus enabling high energy density solid-state lithium metal batteries. The use of blade-coatable ionogels enables both processability via the formulation of a blade-coatable slurry and cell performance by maintaining high ionic conductivity. This combination of attributes enables lithium-ion battery cells with high energy density that can be produced with existing manufacturing equipment and processes.

The blade-coatable ionogel according to the invention can be applied in solid-state batteries, lithium-ion batteries, supercapacitors, transistors, neuromorphic computing devices, flexible electronics, printed electronics, and the likes.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

Some references, which may include patents, patent applications, and various publications, are cited and discussed in the description of this invention. The citation and/or discussion of such references is provided merely to clarify the description of the invention and is not an admission that any such reference is “prior art” to the invention described herein. All references cited and discussed in this specification are incorporated herein by reference in their entireties and to the same extent as if each reference was individually incorporated by reference.

### LIST OF REFERENCES

[1]. Mann, M.; Babinec, S.; Hendrickson, S.; Ho, H.; Spitsen, P. Energy Storage Grand Challenge: Energy Storage Market Report; DOE/GO-102020-5497; U.S. Department of Energy, Washington, D C, USA, 2020. https://www.energy.gov/energy-storage-grand-challenge/downloads/energy-storage-market-report-2020 (accessed 2021 Aug. 10).
[2]. Van Noorden, R. The Rechargeable Revolution: A Better Battery. Nature 2014, 507 (7490), 26-28. DOI: 10.1038/507026a.
[3]. Liu, K.; Liu, Y.; Lin, D.; Pei, A.; Cui, Y. Materials for Lithium-ion Battery Safety. Sci Adv. 2018, 4 (6), eaas9820. DOI: 10.1126/sciadv.aas9820.
[4]. Lin, D.; Liu, Y.; Cui, Y. Reviving the Lithium Metal Anode for High-Energy Batteries. Nat. Nanotechnol. 2017, 12 (3), 194-206. DOI: 10.1038/nnano.2017.16.
[5]. Liu, B.; Zhang, J.-G.; Xu, W. Advancing Lithium Metal Batteries. Joule 2018, 2 (5), 833-845. DOI: 10.1016/j.joule.2018.03.008.
[6]. Cheng, X.-B.; Zhang, R.; Zhao, C.-Z.; Zhang, Q. Toward Safe Lithium Metal Anode in Rechargeable Batteries: A Review. Chem. Rev. 2017, 117 (15), 10403-10473. DOI: 10.1021/acs.chemrev.7b00115.
[7]. Tarascon, J. M.; Armand, M. Issues and Challenges Facing Rechargeable Lithium Batteries. Nature 2001, 414 (6861), 359-367. DOI: 10.1038/35104644.
[8]. Zheng, F.; Kotobuki, M.; Song, S.; Lai, M. O.; Lu, L. Review on Solid Electrolytes for All-Solid-State Lithium-Ion Batteries. J. Power Sources 2018, 389, 198-213. DOI: 10.1016/j.jpowsour.2018.04.022.
[9]. Wang, C.; Fu, K.; Kammampata, S. P.; McOwen, D. W.; Samson, A. J.; Zhang, L.; Hitz, G. T.; Nolan, A. M.; Wachsman, E. D.; Mo, Y.; et al. Garnet-Type Solid-State Electrolytes: Materials, Interfaces, and Batteries. Chem. Rev. 2020, 120 (10), 4257-4300. DOI: 10.1021/acs.chemrev.9b00427.
[10]. Lau, J.; DeBlock, R. H.; Butts, D. M.; Ashby, D. S.; Choi, C. S.; Dunn, B. S. Sulfide Solid Electrolytes for Lithium Battery Applications. Adv. Energy Mater. 2018, 8 (27), 1800933. DOI: 10.1002/aenm.201800933.
[11]. Ngai, K. S.; Ramesh, S.; Ramesh, K.; Juan, J. C. A Review of Polymer Electrolytes: Fundamental, Approaches and Applications. Ionics 2016, 22 (8), 1259-1279. DOI: 10.1007/s11581-016-1756-4.
[12]. Manthiram, A.; Yu, X.; Wang, S. Lithium Battery Chemistries Enabled by Solid-State Electrolytes. Nat. Rev. Mater. 2017, 2 (4). DOI: 10.1038/natrevmats.2016.103.
[13]. Duffner, F.; Kronemeyer, N.; Tubke, J.; Leker, J.; Winter, M.; Schmuch, R. Post-Lithium-Ion Battery Cell Production and Its Compatibility with Lithium-Ion Cell Production Infrastructure. Nat. Energy 2021, 6 (2), 123-134. DOI: 10.1038/s41560-020-00748-8.
[14]. Huang, K. J.; Ceder, G.; Olivetti, E. A. Manufacturing Scalability Implications of Materials Choice in Inorganic Solid-State Batteries. Joule 2021, 5 (3), 564-580. DOI: 10.1016/j.joule.2020.12.001.
[15]. Tan, D. H. S.; Banerjee, A.; Chen, Z.; Meng, Y. S. From Nanoscale Interface Characterization to Sustainable Energy Storage Using All-Solid-State Batteries. Nat. Nanotechnol. 2020, 15 (3), 170-180. DOI: 10.1038/s41565-020-0657-x.
[16]. Wu, J.; Yuan, L.; Zhang, W.; Li, Z.; Xie, X.; Huang, Y. Reducing the Thickness of Solid-State Electrolyte Membranes for High-Energy Lithium Batteries. Energy Environ. Sci. 2021, 14 (1), 12-36. DOI: 10.1039/DOEE02241A.
[17]. Ding, X.; Liu, J.; Harris, T. A. L. A Review of the Operating Limits in Slot Die Coating Processes. AIChE J. 2016, 62 (7), 2508-2524. DOI: 10.1002/aic. 15268.
[18]. Sheng, O.; Jin, C.; Luo, J.; Yuan, H.; Fang, C.; Huang, H.; Gan, Y.; Zhang, J.; Xia, Y.; Liang, C.; et al. Ionic Conductivity Promotion of Polymer Electrolyte with Ionic Liquid Grafted Oxides for All-Solid-State Lithium-Sulfur Batteries. J. Mater. Chem. A 2017, 5 (25), 12934-12942. DOI: 10.1039/C7TA03699J.
[19]. Yu, R.; Bao, J.-J.; Chen, T.-T.; Zou, B.-K.; Wen, Z.-Y.; Guo, X.-X.; Chen, C.-H. Solid Polymer Electrolyte Based on Thermoplastic Polyurethane and Its Application in All-Solid-State Lithium Ion Batteries. Solid State Ion. 2017, 309, 15-21. DOI: 10.1016/j.ssi.2017.06.013.
[20]. Riphaus, N.; Strobl, P.; Stiaszny, B.; Zinkevich, T.; Yavuz, M.; Schnell, J.; Indris, S.; Gasteiger, H. A.; Sedlmaier, S. J. Slurry-Based Processing of Solid Electrolytes: A Comparative Binder Study. J. Electrochem. Soc. 2018, 165 (16), A3993-A3999. DOI: 10.1149/2.0961816jes.
[21]. Ates, T.; Keller, M.; Kulisch, J.; Adermann, T.; Passerini, S. Development of an All-Solid-State Lithium Battery by Slurry-Coating Procedures Using a Sulfidic Electrolyte. Energy Storage Mater. 2019, 17, 204-210. DOI: 10.1016/j.ensm.2018.11.011.
[22]. Lee, K.; Kim, S.; Park, J.; Park, S. H.; Coskun, A.; Jung, D. S.; Cho, W.; Choi, J. W. Selection of Binder and Solvent for Solution-Processed All-Solid-State Battery. J. Electrochem. Soc. 2017, 164 (9), A2075-A2081. DOI: 10.1149/2.1341709jes.
[23]. Jiang, Z.; Wang, S.; Chen, X.; Yang, W.; Yao, X., Hu, X., Han, Q., Wang, H. Tape-Casting Lio.34La_{0.56} TiO₃ Ceramic Electrolyte Films Permit High Energy Density of Lithium-Metal Batteries. Adv. Mater. 2020, 32 (6), 1906221. DOI: 10.1002/adma.201906221.
[24]. Guyomard-Lack, A.; Abusleme, J.; Soudan, P.; Lestriez, B.; Guyomard, D.; Bideau, J. L. Hybrid Silica-Polymer Ionogel Solid Electrolyte with Tunable Properties. Adv. Energy Mater. 2014, 4 (8), 1301570. DOI: 10.1002/aenm.201301570.
[25]. Chen, N.; Zhang, H.; Li, L.; Chen, R.; Guo, S. Ionogel Electrolytes for High-Performance Lithium Batteries: A Review. Adv. Energy Mater. 2018, 8 (12), 1702675. DOI: 10.1002/aenm.201702675.
[26]. Hyun, W. J.; Thomas, C. M.; Hersam, M. C. Nanocomposite Ionogel Electrolytes for Solid-State Rechargeable Batteries. Adv. Energy Mater. 2020, 10 (36), 2002135. DOI: 10.1002/aenm.202002135.
[27]. Hyun, W. J.; de Moraes, A. C. M.; Lim, J. M.; Downing, J. R., Park, K. Y.; Tan, M. T. Z.; Hersam, M. C. High-Modulus Hexagonal Boron Nitride Nanoplatelet Gel Electrolytes for Solid-State Rechargeable Lithium-Ion Batteries. ACS Nano 2019, 13 (8), 9664-9672. DOI: 10.1021/acsnano.9b04989.
[28]. Hyun, W. J.; Thomas, C. M.; Luu, N. S.; Hersam, M. C. Layered Heterostructure Ionogel Electrolytes for High-Performance Solid-State Lithium-Ion Batteries. Adv. Mater. 2021, 33 (13), 2007864. DOI: 10.1002/adma.202007864.
[29]. Lewandowski, A.; Świderska-Mocek, A. Ionic Liquids as Electrolytes for Li-Ion Batteries—An Overview of Electrochemical Studies. J. Power Sources 2009, 194 (2), 601-609. DOI: 10.1016/j.jpowsour.2009.06.089.
[30]. Tokuda, H.; Hayamizu, K.; Ishii, K.; Susan, M. A. B. H.; Watanabe, M. Physicochemical Properties and Structures of Room Temperature Ionic Liquids. 2. Variation of Alkyl Chain Length in Imidazolium Cation. J. Phys. Chem. B 2005, 109 (13), 6103-6110. DOI: 10.1021/jp044626d.
[31]. Ishikawa, M.; Sugimoto, T.; Kikuta, M.; Ishiko, E.; Kono, M. Pure Ionic Liquid Electrolytes Compatible with a Graphitized Carbon Negative Electrode in Rechargeable Lithium-Ion Batteries. J. Power Sources 2006, 162 (1), 658-662. DOI: 10.1016/j.jpowsour.2006.02.077.
[32]. Paillard, E.; Zhou, Q.; Henderson, W. A.; Appetecchi, G. B.; Montanino, M.; Passerini, S. Electrochemical and Physicochemical Properties of Py₁₄FSI-Based Electrolytes with LiFSI. J. Electrochem. Soc. 2009, 156 (11), A891. DOI: 10.1149/1.3208048
[33]. Heist, A.; Lee, S.-H. Improved Stability and Rate Capability of Ionic Liquid Electrolyte with High Concentration of LiFSI. J. Electrochem. Soc. 2019, 166 (10), A1860-A1866. DOI: 10.1149/2.0381910jes.
[34]. Periyapperuma, K.; Arca, E.; Harvey, S.; Pathirana, T.; Ban, C.; Burrell, A.; Pozo-Gonzalo, C.; Howlett, P. C. High Current Cycling in a Superconcentrated Ionic Liquid Electrolyte to Promote Uniform Li Morphology and a Uniform LiF-Rich Solid Electrolyte Interphase. ACS Appl. Mater. Interfaces 2020, 12 (37), 42236-42247. DOI: 10.1021/acsami.0c09074.
[35]. Kim, K. K.; Hsu, A.; Jia, X.; Kim, S. M.; Shi, Y.; Hofmann, M.; Nezich, D.; Rodriguez-Nieva, J. F.; Dresselhaus, M.; Palacios, T.; et al. Synthesis of Monolayer Hexagonal Boron Nitride on Cu Foil Using Chemical Vapor Deposition. Nano Lett. 2012, 12 (1), 161-166. DOI: 10.1021/n1203249a.
[36]. Schmitt, M. Slot Die Coating of Lithium-ion Battery Electrodes. Ph.D. Dissertaion, Karlsruhe Institute of Technology, Karlsruhe, Germany, 2015. https://d-nb.info/1100444181/34 (accessed 2021 Feb. 3).
[37]. N,N-dimethyl-formamide. NIST Chemistry WebBook. National Institute of Standards and Technology. https://webbook.nist.gov/chemistry/(accessed 2021 Jun. 25). (CAS R N: 68-12-2).
[38]. Yamada, Y.; Wang, J.; Ko, S.; Watanabe, E.; Yamada, A. Advances and Issues in Developing Salt-Concentrated Battery Electrolytes. Nat. Energy 2019, 4 (4), 269-280. DOI: 10.1038/s41560-019-0336-z.
[39]. Yang, X.; Jiang, M.; Gao, X.; Bao, D.; Sun, Q.; Holmes, N.; Duan, H.; Mukherjee, S.; Adair, K.; Zhao, C.; et al. Determining the Limiting Factor of the Electrochemical Stability Window for PEO-Based Solid Polymer Electrolytes: Main Chain or Terminal-OH Group? Energy Environ. Sci. 2020, 13 (5), 1318-1325. DOI: 10.1039/DOEE00342E
[40]. Chen, X.; He, W.; Ding, L.-X.; Wang, S.; Wang, H. Enhancing Interfacial Contact in All Solid State Batteries with a Cathode-Supported Solid Electrolyte Membrane Framework. Energy Environ. Sci. 2019, 12 (3), 938-944. DOI: 10.1039/C8EE02617C.
[41]. Wu, J.; Rao, Z.; Cheng, Z.; Yuan, L.; Li, Z.; Huang, Y. Ultrathin, Flexible Polymer Electrolyte for Cost-Effective Fabrication of All-Solid-State Lithium Metal Batteries. Adv. Energy Mater. 2019, 9 (46), 1902767. DOI: 10.1002/aenm.201902767.
[42]. Wan, J.; Xie, J.; Kong, X.; Liu, Z.; Liu, K.; Shi, F.; Pei, A.; Chen, H.; Chen, W.; Chen, J.; et al. Ultrathin, Flexible, Solid Polymer Composite Electrolyte Enabled with Aligned Nanoporous Host for Lithium Batteries. Nat. Nanotechnol. 2019, 14 (7), 705-711. DOI: 10.1038/s41565-019-0465-3.
[43]. Jiang, T.; He, P.; Wang, G.; Shen, Y.; Nan, C.-W.; Fan, L.-Z. Solvent-Free Synthesis of Thin, Flexible, Nonflammable Garnet-Based Composite Solid Electrolyte for All-Solid-State Lithium Batteries. Adv. Energy Mater. 2020, 10 (12), 1903376. DOI: 10.1002/aenm.201903376.
[44]. Sun, J.; Yao, X.; Li, Y.; Zhang, Q.; Hou, C.; Shi, Q.; Wang, H. Facilitating Interfacial Stability Via Bilayer Heterostructure Solid Electrolyte Toward High-energy, Safe and Adaptable Lithium Batteries. Adv. Energy Mater. 2020, 10 (31), 2000709. DOI: 10.1002/aenm.202000709.
[45]. Huo, H.; Chen, Y.; Luo, J.; Yang, X., Guo, X., Sun, X. Rational Design of Hierarchical “Ceramic-in-Polymer” and “Polymer-in-Ceramic” Electrolytes for Dendrite-Free Solid-State Batteries. Adv. Energy Mater. 2019, 9 (17), 1804004. DOI: 10.1002/aenm.201804004.
[46]. Yu, D.; Pan, X.; Bostwick, J. E.; Zanelotti, C. J.; Mu, L.; Colby, R. H.; Lin, F.; Madsen, L. A. Room Temperature to 150° C. Lithium Metal Batteries Enabled by a Rigid Molecular Ionic Composite Electrolyte. Adv. Energy Mater. 2021, 11 (12), 2003559. DOI: 10.1002/aenm.202003559.
[47]. Zhang, M.; Zhang, A. M., Chen, Y.; Xie, J.; Xin, Z.-F.; Chen, Y.-J., Kan, Y.-H.; Li, S.-L.; Lan, Y.-Q.; Zhang, Q. Polyoxovanadate-Polymer Hybrid Electrolyte in Solid State Batteries. Energy Storage Mater. 2020, 29, 172-181. DOI: 10.1016/j.ensm.2020.04.017.
[48]. Yan, C.; Zhu, P.; Jia, H.; Du, Z.; Zhu, J.; Orenstein, R.; Cheng, H.; Wu, N.; Dirican, M.; Zhang, X. Garnet-Rich Composite Solid Electrolytes for Dendrite-Free, High-Rate, Solid-State Lithium-Metal Batteries. Energy Storage Mater. 2020, 26, 448-456. DOI: 10.1016/j.ensm.2019.11.018.
[49]. Yan, X.; Li, Z.; Wen, Z.; Han, W. Li/Li-La₃Zr2012/LiFePO₄ All-Solid-State Battery with Ultrathin Nanoscale Solid Electrolyte. J. Phys. Chem. C 2017, 121 (3), 1431-1435. DOI: 10.1021/acs.jpcc.6b10268.
[50]. Cui, Y.; Liang, X.; Chai, J.; Cui, Z.; Wang, Q.; He, W.; Liu, X.; Liu, Z.; Cui, G.; Feng, J. High Performance Solid Polymer Electrolytes for Rechargeable Batteries: A Self-Catalyzed Strategy toward Facile Synthesis. Adv. Sci. 2017, 4 (11), 1700174. DOI: 10.1002/advs.201700174.
[51]. Bi, Z.; Mu, S.; Zhao, N.; Sun, W.; Huang, W.; Guo, X. Cathode Supported Solid Lithium Batteries Enabling High Energy Density and Stable Cyclability. Energy Storage Mater. 2021, 35, 512-519. DOI: 10.1016/j.ensm.2020.11.038.
[52]. Wu, Q.; Yang, Y.; Chen, Z.; Su, Q.; Huang, S.; Song, D.; Zhu, C.; Ma, R.; Li, C. Dendrite-Free Solid-State Li Metal Batteries Enabled by Bifunctional Polymer Gel Electrolytes. ACS Appl. Energy Mater. 2021, 4 (9), 9420-9430. DOI: 10.1021/acsaem.1c01634.
[53]. Hyun, W. J.; de Moraes, A. C. M.; Lim, J. M.; Downing, J. R.; Park, K. Y.; Tan, M. T. Z.; Hersam, M. C. High-Modulus Hexagonal Boron Nitride Nanoplatelet Gel Electrolytes for Solid-State Rechargeable Lithium-Ion Batteries. ACS Nano 2019, 13 (8), 9664-9672. DOI: 10.1021/acsnano.9b04989.
[54]. N,N-dimethyl-formamide. NIST Chemistry WebBook. National Institute of Standards and Technology. https://webbook.nist.gov/chemistry/(accessed 2021 Jun. 25). (CAS R N: 68-12-2).
[55]. Schmitt, M. Slot Die Coating of Lithium-ion Battery Electrodes. Ph.D. Dissertaion, Karlsruhe Institute of Technology, Karlsruhe, Germany, 2015. https://d-nb.info/1100444181/34 (accessed 2021 Feb. 3).
[56]. Rodrigues, M. T. F. et al., Boron nitride-ionic liquid composites and their use for energy storage devices, WO2016141301A1, Sep. 6, 2016.
[57]. Nishimura J. et al., All-Solid lithium secondary battery, US20150017549A1, Jan. 15, 2015.
[58]. Wright P. K. et al., Ionic gel electrolyte, energy storage devices, and methods of manufacture thereof, US20180226680A1, Aug. 9, 2018.
[59]. Oh J. S. et al., Gel polymer electrolyte containing ionic liquid and electrochromic device using the same, U.S. Pat. No. 7,411,716B2, Aug. 12, 2008.
[60]. Singh R. R. et al., Polymer ionic electrolytes, U.S. Pat. No. 7,955,738B2, Jun. 7, 2011.
[61]. Frisbie C. D. and Lodge T. P., Ion gels and electronic devices utilizing ion gels, WO2008097300A3, Aug. 14, 2008.
[62]. Miyachi H. and Takeda R., Method and apparatus for producing solid electrolyte membrane, EP2002451B1, Oct. 11, 2007.

1. An ionogel, comprising:
an ionic liquid electrolyte (ILE) comprising 1-ethyl-3-methyl-imidazolium bis(fluorosulfonyl)imide (EMIM-FSI) and lithium bis(fluorosulfonyl)imide (LiFSI) dissolved in the EMIM-FSI; and
a solid matrix material comprising hexagonal boron nitride (hBN) nanoplatelets mixed with the ionic liquid electrolyte in at least one solvent.

2. The ionogel of claim 1, wherein the EMIM-FSI has relatively low viscosity and high ionic conductivity of the imidazolium cation, while the FSI anion provides cathodic stability down to 0 V vs. Li/Li⁺.

3. The ionogel of claim 1, wherein the ILE has a high concentration of the LiFSI for enhancing the stability of lithium plating and generating a favorable LiF-rich solid electrolyte interface (SEI) with lithium metal.

4. The ionogel of claim 3, wherein the ILE contains about 30-50 mol % of the LiFSI.

5. The ionogel of claim 1, wherein the hBN nanoplatelets comprise exfoliated hBN nanoplatelets.

6. The ionogel of claim 5, wherein each exfoliated hBN nanoplatelet is coated with a thin amorphous carbon coating.

7. The ionogel of claim 1, wherein the hBN Nanoplatelets have desirable physical properties including thermal stability, chemical inertness, electrically insulating nature, and mechanical robustness.

8. The ionogel of claim 1, wherein the hBN nanoplatelets have the high surface area for generating strong interactions with the ILE, thereby confining the ILE and generating a high mechanical modulus gel that is greater than about 1 MPa.

9. The ionogel of claim 1, wherein the at least one solvent is a polar solvent selected to create a well-mixed slurry and provide favorable thermodynamic properties for thermal removal.

10. The ionogel of claim 9, having a viscosity that is tunable by the at least one solvent.

11. The ionogel of claim 10, wherein the at least one solvent is adapted to tune the viscosity of the ionogel to match that of existing commercial blade coating slurries that is about 10⁴ cP at a shear rate of 100 s⁻¹ used in high-throughput coating equipment.

12. The ionogel of claim 9, wherein the at least one solvent is operably removable with a thermal treatment.

13. The ionogel of claim 9, wherein the at least one solvent comprises N,N-dimethylformamide (DMF), diglyme, N-methyl-pyrrolidone, or 1,4-dioxane.

14. The ionogel of claim 1, comprising about 15-25 wt % of the hBN nanoplatelets, about 25-35 wt % of the ILE, and more than 50 wt % of the at least one solvent.

15. The ionogel of claim 1, being a blade-coatable ionogel that is capable of forming a blade-coated film having a thickness of less than about 40 μm with crack-free without use of a polymeric binder.

16. The ionogel of claim 15, being coatable directly onto a composite cathode, and providing excellent interfacial contact with low impedance.

17. The ionogel of claim 16, wherein the blade-coated film is a blade-coated solid-state electrolyte (SSE) film for a lithium metal battery (LMB).

18. The ionogel of claim 17, wherein the SSE film has sufficient mechanical stiffness to inhibit growth of lithium dendrites with a storage modulus of greater than about 1 MPa, while also provides excellent interfacial contact to the composite cathode and a lithium metal anode.

19. The ionogel of claim 17, wherein the SSE film is electrochemically stable against lithium metal enabling its utilization in LFP|Li cells that can be cycled at 1C rate with an about 78% capacity retention after about 500 cycles at room temperature.

20. The ionogel of claim 17, wherein the thermal stability of the hBN nanoplatelets and the ILE allows for operation of LFP|Li cells at about 60° C. with an about 33% improvement in gravimetric capacity at 1C compared to room temperature.

21. The ionogel of claim 1, wherein ionic conductivity of the ionogel remains high with values of about 1.6 mS cm⁻¹ and about 5.5 mS cm⁻¹ at room temperature and about 60° C., respectively.

22. An ionogel, comprising:
an ionic liquid electrolyte (ILE); and
a solid matrix material mixed with the ionic liquid electrolyte.

23. The ionogel of claim 22, wherein the ILE comprises an ionic liquid comprising at least one of 1-ethyl-3-methyl-imidazolium bis(fluorosulfonyl)imide (EMIM-FSI), 1-ethyl-3-methyl-imidazolium bis(trifluoromethylsulfonyl)imide (EMIM-TFSI), N-methyl-N-propylpyrrolidinium bis(trifluoromethylsulfonyl)imide (Py₁₃-TFSI), and N-methyl-N-propylpyrrolidinium bis(fluorosulfonyl)imide (Py₁₃-TFSI), or a combination of the ionic liquid along with an lithium salt comprising at least one of lithium bis(fluorosulfonyl)imide (LiFSI), lithium bis(trifluoromethylsulfonyl)imide (LiTFSI), and lithium bis(oxalato) borate (LiBOB), or a combination of the lithium salt dissolved in the ionic liquid.

24. The ionogel of claim 22, wherein the solid matrix material is selected to have desirable physical properties including thermal stability, chemical inertness, electrically insulating nature, and mechanical robustness.

25. The ionogel of claim 24, wherein the solid matrix material comprises boron nitride nanosheets (BNNS), borocarbonitrides (BCN), oxide nanosheets, layered perovskites, hydroxide nanosheets including hydrotalcite-like layered double hydroxides, natural clays including bentonites and montmorillonites, or a combination of them.

26. The ionogel of claim 25, wherein the oxide nanosheets comprise Al₂O₃, TiO₂ (anatase and rutile), ZrO₂, Nb₂O₅, HfO₂, CaCu₃Ti₄O₁₂, Pb(Zr,Ti)O₃, (Pb,La)(Zr,Ti)O₃, SiO₂, Al₂O₃, HfSiO₄, ZrO₂, HfO₂, Ta₂O₅, La₂O₃, LaALO₃, Nb₂O₅, BaTiO₃, SrTiO₃, Ta₂O₅, or a combination of them.

27. The ionogel of claim 25, wherein the BNNS comprises hexagonal boron nitride (hBN) nanoplatelets.

28. The ionogel of claim 27, wherein the hBN nanoplatelets comprise exfoliated hBN nanoplatelets.

29. The ionogel of claim 28, wherein each exfoliated hBN nanoplatelet is coated with a thin amorphous carbon coating.

30. The ionogel of claim 22, wherein the solid matrix material is mixed with the ionic liquid electrolyte in at least one solvent.

31. The ionogel of claim 30, wherein the at least one solvent is a polar solvent selected to create a well-mixed slurry as well as provide favorable thermodynamic properties for thermal removal.

32. The ionogel of claim 31, having a viscosity that is tunable by the at least one solvent.

33. The ionogel of claim 32, wherein the at least one solvent is adapted to tune the viscosity of the ionogel to match that of existing commercial blade coating slurries (that is about 10⁴ cP at a shear rate of 100 s⁻¹ used in high-throughput coating equipment.

34. The ionogel of claim 30, wherein the at least one solvent is operably removable with a thermal treatment.

35. The ionogel of claim 30, wherein the at least one solvent comprises N,N-dimethylformamide (DMF), diglyme, N-methyl-pyrrolidone, or 1,4-dioxane.

36. The ionogel of claim 30, being a blade-coatable ionogel that is capable of forming a blade-coated film having a thickness of less than about 40 μm with crack-free without use of a polymeric binder.

37. The ionogel of claim 36, being coatable directly onto a composite cathode, and providing excellent interfacial contact with low impedance.

38. The ionogel of claim 37, wherein the blade-coated film is a blade-coated solid-state electrolyte (SSE) film for a lithium metal battery (LMB).

39. The ionogel of claim 38, wherein the SSE film has sufficient mechanical stiffness to inhibit growth of lithium dendrites with a storage modulus of greater than about 1 MPa, while also provides excellent interfacial contact to the composite cathode and a lithium metal anode.

40. The ionogel of claim 38, wherein the SSE film is electrochemically stable against lithium metal enabling its utilization in LFP|Li cells that can be cycled at 1C rate with an about 78% capacity retention after about 500 cycles at room temperature.

41. The ionogel of claim 38, wherein the thermal stability of the hBN nanoplatelets and the ILE allows for operation of LFP|Li cells at about 60° C. with an about 33% improvement in gravimetric capacity at 1C compared to room temperature.

42. The ionogel of claim 22, wherein ionic conductivity of the ionogel remains high with values of about 1.6 mS cm⁻¹ and about 5.5 mS cm⁻¹ at room temperature and about 60° C., respectively.

43. The ionogel of claim 30, comprising about 15-25 wt % of the solid matrix material, about 25-35 wt % of the ILE, and about 50 wt % of the at least one solvent.

44. A device, comprising:
one or more components formed of the ionogel according to claim 1.

45. The device of claim 44, being one or more batteries, one or more supercapacitors, or any combination of them.

46. A method for forming an ionogel, comprising:
providing an ionic liquid electrolyte (ILE) and a solid matrix material; and
mixing the solid matrix material with the ILE in at least one solvent.

47. The method of claim 46, wherein the ILE comprises an ionic liquid comprising at least one of 1-ethyl-3-methyl-imidazolium bis(fluorosulfonyl)imide (EMIM-FSI), 1-ethyl-3-methyl-imidazolium bis(trifluoromethylsulfonyl)imide (EMIM-TFSI), N-methyl-N-propylpyrrolidinium bis(trifluoromethylsulfonyl)imide (Py₁₃-TFSI), and N-methyl-N-propylpyrrolidinium bis(fluorosulfonyl)imide (Py₁₃-TFSI), or a combination of the ionic liquid along with an lithium salt comprising at least one of lithium bis(fluorosulfonyl)imide (LiFSI), lithium bis(trifluoromethylsulfonyl)imide (LiTFSI), and lithium bis(oxalato) borate (LiBOB), or a combination of the lithium salt dissolved in the ionic liquid.

48. The method of claim 46, wherein the solid matrix material is selected to have desirable physical properties including thermal stability, chemical inertness, electrically insulating nature, and mechanical robustness.

49. The method of claim 48, wherein the solid matrix material comprises boron nitride nanosheets (BNNS), borocarbonitrides (BCN), oxide nanosheets, layered perovskites, hydroxide nanosheets including hydrotalcite-like layered double hydroxides, natural clays including bentonites and montmorillonites, or a combination of them.

50. The method of claim 49, wherein the oxide nanosheets comprise Al₂O₃, TiO₂ (anatase and rutile), ZrO₂, Nb₂O₅, HfO₂, CaCu₃Ti₄O₁₂, Pb(Zr,Ti)O₃, (Pb,La)(Zr,Ti)O₃, SiO₂, Al₂O₃, HfSiO₄, ZrO₂, HfO₂, Ta₂O₅, La₂O₃, LaALO₃, Nb₂O₅, BaTiO₃, SrTiO₃, Ta₂O₅, or a combination of them.

51. The method of claim 49, wherein the BNNS comprises hexagonal boron nitride (hBN) nanoplatelets that are obtained by shear-mixing bulk hBN microparticles in ethanol with ethyl cellulose (EC) acting as a dispersing agent to form a shear-mixed dispersion;
separating the exfoliated hBN nanoplatelets and EC from the shear-mixed dispersion by centrifuge-assisted sedimentation and flocculation; and collecting hBN/EC solids; and
heating the collected hBN/EC solids at a temperature for a period of time to decompose the EC, thereby volatilizing most of the EC, but also leaving behind a thin amorphous carbon coating on the surface of each of the exfoliated hBN nanoplatelets, which contributes to enhanced interactions between the hBN nanoplatelets and the ionic liquids for stronger solidification of the ionogel ink.

52. The method of claim 51, wherein the temperature is about 300-500° C., and the period of time is for about 2-4 hours.

53. The method of claim 46, wherein the ionogel have a viscosity that is tunable by the at least one solvent.

54. The method of claim 53, wherein the at least one solvent is adapted to tune the viscosity of the ionogel to match that of existing commercial blade coating slurries that is about 10⁴ cP at a shear rate of 100 s⁻¹ used in high-throughput coating equipment.

55. The method of claim 46, wherein the at least one solvent is operably removable with a thermal treatment.

56. The method of claim 46, wherein the at least one solvent comprises N,N-dimethylformamide (DMF), diglyme, N-methyl-pyrrolidone, or 1,4-dioxane.
